(19) United States
(12) Patent Application Publication
(10) Pub. No.: US 2026/0171283 A1
(43) Pub. Date: Jun. 18, 2026

(54) PATH RESTRICTION MEMBER AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masahiro HAGI, Mie (JP); Weichi WANG, Mie (JP)

(21) Appl. No.: 19/129,303

(22) PCT Filed: Nov. 8, 2023
(86) PCT No.: PCT/JP2023/040136

§ 371 Date: May 13, 2025

(30) Foreign Application Priority Data
Nov. 22, 2022 (JP) 2022-186704
May 15, 2023 (JP) 2023-080150

(51) Int. Cl. H01B 7/00; B60R 16/02

(52) U.S. Cl. CPC H01B 7/0045; B60R 16/0207

(57) ABSTRACT

A path restriction member (20) includes a bent component (60) having a holding portion (61) that holds an electric wire member and has a bent portion (60R), a coupling portion (70A), a coupling portion (75A), a coupling portion (70B) having the same structure as the coupling portion (70A), and a coupling portion (75B) having the same structure as the coupling portion (75A). The path restriction member (20) includes a straight component (30) having a holding portion (31) that holds an electric wire member, a coupling portion (40A) that is coupled to the coupling portion (75A), and a coupling portion (45A) that is coupled to the coupling portion (70A). The holding portion (61) has a bottom wall (62) and a pair of side walls (63, 64).

### TECHNICAL FIELD

The present disclosure relates to a path restriction member and a wire harness.

### BACKGROUND

Conventionally, a wire harness routed inside a vehicle such as a hybrid automobile or an electric automobile is known which includes an electric wire member and a path restriction member that restricts the path of the electric wire member (e.g., see Patent Document 1). The path restriction member is provided, for example, at a bent portion in the routing path of the electric wire member. The path restriction member maintains the bent shape of the bent portion of the electric wire member.

### PRIOR ART DOCUMENT

### Patent Document

Patent Document 1: JP 2015-047015 A

### SUMMARY OF THE INVENTION

### Problems to be Solved

Incidentally, in the above-mentioned wire harness, for each location where a path restriction member is required to be provided on the electric wire member, a path restriction member having a shape that matches that location needs to be prepared. For example, at the bent portion of the electric wire member, it is necessary to prepare a path restriction member having a shape that matches the bent path at the bent portion. Accordingly, there have been problems with the complexity of component management and increased costs involved with the path restriction member.

An object of the present disclosure is to provide a path restriction member and a wire harness according to which versatility can be improved.

### Means to Solve the Problem

A path restriction member of the present disclosure is a path restriction member for restricting a path of an electric wire member, the path restriction member including: a bent component including a first holding portion that is configured to hold the electric wire member and has a bent portion, a first coupling portion, a second coupling portion, a third coupling portion having the same structure as the first coupling portion, and a fourth coupling portion having the same structure as the second coupling portion; and a restricting component including a second holding portion configured to hold the electric wire member, a fifth coupling portion coupled to the second coupling portion, and a sixth coupling portion coupled to the first coupling portion, in which the first holding portion has a first bottom wall, and a first side wall and a second side wall protruding from both side edges of the first bottom wall, the bent component has a first end portion and a second end portion in an axial direction of the bent component, the first coupling portion is provided at the first end portion on the first side wall, the second coupling portion is provided at the first end portion on the second side wall, the third coupling portion is provided at the second end portion on the second side wall, and the fourth coupling portion is provided at the second end portion on the first side wall.

### Effect of the Invention

The path restriction member and the wire harness according to the present disclosure have an effect of being able to improve versatility.

### BRIEF DESCRIPTION OF THE DRAWINGS

FIG. 1 is a schematic configuration diagram showing a wire harness according to a first embodiment.

FIG. 2 is a plan view showing the wire harness according to the first embodiment.

FIG. 3 is an enlarged plan view of a portion of the wire harness according to the first embodiment.

FIG. 4 is a perspective view showing the wire harness according to the first embodiment.

FIG. 5 is an exploded perspective view showing a path restriction member according to the first embodiment.

FIG. 6 is a perspective view showing a straight component according to the first embodiment.

FIG. 7 is a side view showing the straight component according to the first embodiment.

FIG. 8 is a perspective view showing a bent component of the first embodiment.

FIG. 9 is a cross-sectional perspective view showing a path restriction member according to the first embodiment.

FIG. 10 is a side view showing the path restriction member according to the first embodiment.

FIG. 11 is a perspective view showing the wire harness according to the first embodiment.

FIG. 12 is a perspective view showing a method for manufacturing the path restriction member according to the first embodiment.

FIG. 13 is a perspective view showing a method for manufacturing the path restriction member according to the first embodiment.

FIG. 14 is a perspective view showing a method for manufacturing the path restriction member according to the first embodiment.

FIG. 15 is a perspective view showing a method for manufacturing the path restriction member according to the first embodiment.

FIG. 16 is an exploded perspective view showing a path restriction member according to a modified example.

FIG. 17 is a plan view showing a path restriction member according to a modified example.

FIG. 18 is a perspective view showing a wire harness according to a modified example.

FIG. 19 is a perspective view showing a straight component according to a modified example.

FIG. 20 is a perspective view showing a bent component according to a modified example.

FIG. 21 is a perspective view showing a wire harness according to a second embodiment.

FIG. 22 is an exploded perspective view showing a path restriction member according to the second embodiment.

FIG. 23 is an exploded perspective view showing the path restriction member according to the second embodiment.

FIG. 24 is a plan view showing the path restriction member according to the second embodiment.

FIG. 25 is an end view (end view taken along line 25-25 in FIG. 24) showing the path restriction member according to the second embodiment.

FIG. 26 is an exploded end view showing a path restriction member according to a modified example.

FIG. 27 is an end view showing a path restriction member according to a modified example.

FIG. 28 is an exploded perspective view showing a path restriction member according to a modified example.

FIG. 29 is an exploded perspective view showing a path restriction member according to a modified example.

FIG. 30 is an exploded perspective view showing a path restriction member according to a modified example.

FIG. 31 is an exploded side view showing a path restriction member according to a modified example.

FIG. 32 is a perspective view showing a wire harness according to a modified example.

### DETAILED DESCRIPTION TO EXECUTE THE INVENTION

### Description of Embodiments of Present Disclosure

First, embodiments of the present disclosure will be listed and described.

[1] The path restriction member according to the present disclosure is a path restriction member for restricting a path of an electric wire member, the path restriction member including: a bent component including a first holding portion that is configured to hold the electric wire member and has a bent portion, a first coupling portion, a second coupling portion, a third coupling portion having the same structure as the first coupling portion, and a fourth coupling portion having the same structure as the second coupling portion; and a restricting component including a second holding portion configured to hold the electric wire member, a fifth coupling portion coupled to the second coupling portion, and a sixth coupling portion coupled to the first coupling portion, in which the first holding portion has a first bottom wall, and a first side wall and a second side wall protruding from both side edges of the first bottom wall, the bent component has a first end portion and a second end portion in an axial direction of the bent component, the first coupling portion is provided at the first end portion on the first side wall, the second coupling portion is provided at the first end portion on the second side wall, the third coupling portion is provided at the second end portion on the second side wall, and the fourth coupling portion is provided at the second end portion on the first side wall.

According to this configuration, at the first end portion of the bent component, the first coupling portion is provided on the first side wall, and the second coupling portion is provided on the second side wall. On the other hand, at the second end portion of the bent component, the third coupling portion having the same structure as the first coupling portion is provided on the second side wall, and the fourth coupling portion having the same structure as the second coupling portion is provided on the first side wall. In this manner, the third coupling portion and the fourth coupling portion at the second end portion of the bent component are formed in a structure that is a 180-degree rotation of the structure of the first coupling portion and the second coupling portion at the first end portion of the bent component. For this reason, the restricting component can be coupled to the first end portion of the bent component, and can be coupled also to the second end portion of the bent component. That is, the restricting component can be connected to either the first end portion or the second end portion of the bent component. As a result, by appropriately changing the coupling direction of the restricting component with respect to the bent component according to the path of the electric wire member, bent components having the same configuration and restricting components having the same configuration can be used in common for two or more types of bent paths. Accordingly, compared to the conventional method in which it was necessary to prepare a path restriction member having a different shape for each bent path, the versatility of the path restriction member can be improved.

[2] In [1] above, the restricting component may include the fifth coupling portion having the same structure as the first coupling portion, the sixth coupling portion having the same structure as the second coupling portion, a seventh coupling portion having the same structure as the fifth coupling portion, and an eighth coupling portion having the same structure as the sixth coupling portion, the second holding portion may have a second bottom wall, and a third side wall and a fourth side wall protruding from both side edges of the second bottom wall, the second holding portion may have a third end portion and a fourth end portion in an axial direction of the second holding portion, the fifth coupling portion may be provided at the third end portion on the third side wall, the sixth coupling portion may be provided at the third end portion on the fourth side wall, the seventh coupling portion may be provided at the fourth end portion on the fourth side wall, and the eighth coupling portion may be provided at the fourth end portion on the third side wall.

According to this configuration, at the third end portion of the restricting component, the fifth coupling portion is provided on the third side wall, and the sixth coupling portion is provided on the fourth side wall. On the other hand, at the fourth end portion of the restricting component, the seventh coupling portion having the same structure as the fifth coupling portion is provided on the fourth side wall, and the eighth coupling portion having the same structure as the sixth coupling portion is provided on the third side wall. In this manner, the structure of the seventh coupling portion and the eighth coupling portion at the fourth end portion of the restricting component is formed to have a structure that is a 180-degree rotation of the structure of the fifth coupling portion and the sixth coupling portion at the third end portion of the restricting component. For this reason, the bent component can be coupled to either the third end portion or the fourth end portion of the restricting component. As a result, by appropriately changing the coupling direction of the bent component with respect to the restricting component according to the path of the electric wire member, bent components having the same configuration and restricting components having the same configuration can be used in common for two or more types of bent paths. Accordingly, the versatility of the path restriction member can be improved.

[3] In [1] or [2] above, the first coupling portion may be engaged with the sixth coupling portion in an axial direction of the path restriction member, and the second coupling portion may be engaged with the fifth coupling portion in the axial direction of the path restriction member.

According to this configuration, when the first coupling portion is coupled to the sixth coupling portion, the first coupling portion and the sixth coupling portion are engaged with each other in the axial direction of the path restriction member. Also, when the second coupling portion is coupled to the fifth coupling portion, the second coupling portion and the fifth coupling portion are engaged with each other in the axial direction of the path restriction member. This makes it possible to suitably suppress movement of the restricting component relative to the bent component in the axial direction of the path restriction member.

[4] In [3] above, the first coupling portion may have a protruding portion protruding from the first end portion on the first side wall along an axial direction of the first holding portion, and an engaging projection protruding from a leading end of the protruding portion along a height direction of the first side wall, the sixth coupling portion may have a first recess into which the protruding portion fits and a second recess into which the engaging projection fits, and a side surface of the engaging projection may be engaged with an inner surface of the second recess in the axial direction of the path restriction member.

According to this configuration, when the first coupling portion is coupled to the sixth coupling portion, the side surface of the engaging projection of the first coupling portion and the inner surface of the second recess of the sixth coupling portion engage with each other in the axial direction of the path restriction member. This makes it possible to suitably suppress movement of the restricting component relative to the bent component in the axial direction of the path restriction member.

[5] In [4] above, each of the first side wall and the second side wall may be formed in a plate shape, and a length of the engaging projection along the axial direction of the path restriction member may be greater than a length of the first side wall along a thickness direction of the first side wall.

According to this configuration, the length of the engaging projection along the axial direction of the path restriction member, that is, the length of the engaging projection along the direction of engaging with the inner surface of the second recess, is formed to be large. For this reason, even if, for example, an external force that causes the side surface of the engaging projection and the inner surface of the second recess to press against each other is applied in the above-described axial direction from the electric wire member or the like to the path restriction member, it is possible to suitably suppress damage to the engaging projection caused by the external force.

[6] In any one of [1] to [5] above, in a plan view from a height direction of the first side wall, the bent component may have a first engagement portion provided at a position overlapping with the first coupling portion, a second engagement portion provided at a position overlapping with the second coupling portion, a third engagement portion provided at a position overlapping with the third coupling portion, and a fourth engagement portion provided at a position overlapping with the fourth coupling portion, the restricting component may have a fifth engagement portion engaged with the second engagement portion in the peripheral direction of the path restriction member, and a sixth engagement portion engaged with the first engagement portion in the peripheral direction of the path restriction member, each of the third engagement portion and the fifth engagement portion may have the same structure as the first engagement portion, and each of the fourth engagement portion and the sixth engagement portion may have the same structure as the second engagement portion.

According to this configuration, the first engagement portion of the bent component and the sixth engagement portion of the restricting component are engaged with each other in the peripheral direction of the path restriction member. Also, the second engagement portion of the bent component and the fifth engagement portion of the restricting component are engaged with each other in the peripheral direction of the path restriction member. This makes it possible to suitably suppress movement of the restricting component relative to the bent component in the peripheral direction of the path restriction member.

[7] In [6] above, the first engagement portion may have a base portion that protrudes outward of the first holding portion along the axial direction of the first holding portion from an outer peripheral surface of the first holding portion, an elastic piece that protrudes from a leading end of the base portion along the peripheral direction of the first holding portion, and an engagement claw that is provided at a leading end of the elastic piece and is engaged with the sixth engagement portion.

According to this configuration, the engagement claw of the first engagement portion and the sixth engagement portion can be suitably engaged with each other by a snap-fit method utilizing the elastic deformation of the elastic piece of the first engagement portion. The engagement of the engagement claw of the first engagement portion with the sixth engagement portion makes it possible to suitably suppress movement of the restricting component relative to the bent component in the peripheral direction of the path restriction member.

[8] In [1] or [2] above, a coupling tool coupling the first coupling portion and the sixth coupling portion may be further included, the first coupling portion may include a fixing portion that protrudes outward of the first holding portion along the axial direction of the first holding portion from an outer peripheral surface of the first side wall, and a through hole provided in the fixing portion, the sixth coupling portion may include a third recess that is in communication with the through hole, the fixing portion may be engaged with an outer peripheral surface of the restricting component in a radial direction of the first holding portion, and the coupling tool may have a columnar insertion portion inserted into the through hole and the third recess.

According to this configuration, the insertion portion of the coupling tool is inserted into the through hole of the first coupling portion and the third recess of the sixth coupling portion. The first coupling portion and the sixth coupling portion are coupled to each other by this coupling tool. Also, when the first coupling portion is coupled to the sixth coupling portion, the fixing portion of the first coupling portion and the outer peripheral surface of the restricting component are engaged with each other in the radial direction of the first holding portion. This makes it possible to suitably suppress movement of the restricting component relative to the bent component in the radial direction of the first holding portion.

[9] In [8] above, the first coupling portion may include an annular first elastic member that is provided inside the through hole and has a first insertion hole, the sixth coupling portion may include an annular second elastic member that is provided inside the third recess and has a second insertion hole, the coupling tool may be a coupling pin having a head portion and the insertion portion that extends from the head portion and is inserted into the first insertion hole and the second insertion hole, and an outer diameter of the insertion portion is set to be greater than or equal to an inner diameter of the first insertion hole and greater than or equal to an inner diameter of the second insertion hole.

According to this configuration, the insertion portion of the coupling pin is inserted into the first insertion hole of the first elastic member provided inside the through hole and the second insertion hole of the second elastic member provided inside the third recess. The first coupling portion and the sixth coupling portion are coupled by this coupling pin. At this time, the outer diameter of the insertion portion is set to be greater than or equal to the inner diameter of the first insertion hole and is set to be greater than or equal to the inner diameter of the second insertion hole. For this reason, the inner peripheral surface of the first elastic member can be suitably brought into areal contact with the outer peripheral surface of the insertion portion, and the inner peripheral surface of the second elastic member can be suitably brought into areal contact with the outer peripheral surface of the insertion portion. As a result, it is possible to suitably suppress the coupling pin from coming out of the first insertion hole and the second insertion hole.

[10] In [8] or [9] above, the coupling tool may be a coupling pin that has a head portion having an opposing surface opposing the fixing portion, the insertion portion that extends from the opposing surface and is inserted into the through hole and the third recess, and an elastic member with adhesive, the elastic member with adhesive being provided on the opposing surface, a portion of the adhesive of the elastic member with adhesive may permeate into the through hole and the third recess, and the insertion portion may be adhered to the first coupling portion by the adhesive and may be adhered to the sixth coupling portion by the adhesive.

According to this configuration, the insertion portion of the coupling pin is adhered to the first coupling portion and the sixth coupling portion by the adhesive. This makes it possible to suitably suppress the coupling pin from coming out of the through hole and the third recess.

[11] In [8] above, the coupling tool may have a male thread having the insertion portion and a female thread fastened to the male thread, and the first coupling portion may be screw-fastened to the sixth coupling portion by the male thread and the female thread.

According to this configuration, the first coupling portion and the sixth coupling portion are coupled by screw fastening using the male thread and the female thread. This makes it possible to effectively suppress the male thread and the female thread, which are the coupling tool, from coming out of the through hole of the first coupling portion and the third recess of the sixth coupling portion.

[12] In [11] above, the female thread may be a nut provided inside the third recess, the sixth coupling portion may be molded with the nut as an insert part, the female thread may be a nut that is provided inside the third recess and is formed in one piece with the sixth coupling portion, the male thread may be a bolt having a head portion and the insertion portion extending from the head portion, and a leading end of the insertion portion may be fastened to the nut while passing through the through hole.

According to this configuration, the nut is formed in one piece with the sixth coupling portion, and the leading end of the insertion portion of the bolt is fastened to the nut. The first coupling portion and the sixth coupling portion can be suitably coupled by screw fastening using this nut and bolt.

[13] In [12] above, the first coupling portion may have a rib protruding toward an outer side in a radial direction of the first holding portion from an outer peripheral surface of the fixing portion, the rib may be formed so as to surround the through hole in a plan view from a penetration direction of the through hole, and the rib is in contact with the head portion of the bolt.

According to this configuration, the rib is provided on the portion of the outer peripheral surface of the fixing portion that comes into contact with the head of the bolt. The rib can increase the rigidity of the fixing portion. For this reason, when the bolt is fastened to the nut, the fastening force can be suitably suppressed from causing cracks or the like in the fixing portion.

[14] In any one of [1] to [13] above, the restricting component may be a straight component formed so as to extend linearly in one direction.

According to this configuration, the straight component can be coupled to both the first end portion and the second end portion of the bent component. As a result, by appropriately changing the coupling direction of the straight component with respect to the bent component according to the path of the electric wire member, bent components having the same configuration and straight components having the same configuration can be used in common for two or more types of bent paths. Accordingly, the versatility of the path restriction member can be improved.

[15] In any one of [1] to [13] above, when the bent component is a first bent component, the restricting component may be a second bent component having the same structure as the first bent component.

According to this configuration, the first bent component and the second bent component having the same structure as each other are directly coupled to each other. This makes it possible to change the bending angle of the path restriction member compared to when there is one bent component. In this manner, by adjusting the number of coupled bent components having the same configuration, the bending angle of the path restriction member can be easily changed.

[16] In any one of [1] to [15] above, the bent component may have a first insertion opening that is open in a direction perpendicular to the axial direction of the bent component and extends over the entire length in the axial direction of the bent component, the restricting component may have a second insertion opening that is open in a direction perpendicular to the axial direction of the restricting component and extends over the entire length in the axial direction of the restricting component, and the first insertion opening may be in communication with the second insertion opening.

According to this configuration, the first insertion opening that is open in a direction perpendicular to the axial direction of the bent component and the second insertion opening that is open in a direction perpendicular to the axial direction of the restricting component are in communication with each other. This makes it possible to attach the path restriction member to the electric wire member through the first insertion opening and the second insertion opening after performing terminal processing such as attaching a connector to an end portion in the axial direction of the electric wire member. In this manner, since the path restriction member can be retrofitted to the electric wire member, it is possible to improve the assembly workability of the wire harness.

[17] The wire harness according to the present disclosure includes the path restriction member according to any one of [1] to [16] above, and the electric wire member whose path is restricted by the path restriction member.

According to this configuration, it is possible to obtain the same effect as the path restriction member described in [1] above.

### DETAILS OF EMBODIMENTS OF THE PRESENT DISCLOSURE

Specific examples of the path restriction member and the wire harness according to the present disclosure will be described below with reference to the drawings. In each drawing, for convenience of description, some parts of the configuration may be exaggerated or simplified. In addition, the dimensional proportions of each part may differ between drawings. In this specification, “perpendicular”, “parallel”, and “full length” do not only mean strictly perpendicular, parallel, and full length, but also include approximately perpendicular, parallel, and full length within the range in which the effects of this embodiment are achieved. In this specification, “same” or “equal” refers not only to being exactly the same or exactly equal, but also to cases where there is some difference between the objects being compared due to the influence of dimensional tolerances and the like. In addition, the term “tubular” as used in the description of this specification does not only refer to a tubular shape in which a peripheral wall is continuous over the entire periphery in the peripheral direction, but also includes a tubular shape formed by combining a plurality of components, and a C-shape or U-shape having a notch or the like in part of the peripheral direction. Note that “tubular” shapes include, but are not limited to, circles, ellipses, and polygons with sharp or rounded corners. In addition, the term “annular” as used in this description may refer to any structure that forms a loop, or a continuous shape with no end portions. “Annular” shapes include, but are not limited to, circles, ellipses, and polygons with sharp or rounded corners. In addition, in this specification, “opposing” refers to surfaces or members being at positions in front of each other, and includes not only cases where they are completely in front of each other, but also cases where they are partially in front of each other. In addition, in this specification, “opposing” includes both a case where a member other than two parts is interposed between the two parts, and a case where nothing is interposed between the two parts. Also, some of the drawings show an X-axis, a Y-axis, and a Z-axis, which are perpendicular to each other. In the following description, for convenience, the direction extending along the X-axis is referred to as the X-axis direction, the direction extending along the Y-axis is referred to as the Y-axis direction, and the direction extending along the Z-axis is referred to as the Z-axis direction. In addition, terms such as “first”, “second”, and “third” in this specification are used simply to distinguish objects and are not used to rank the objects. Note that the present invention is not limited to these examples, but is indicated by the claims, and all modifications within the meaning and range equivalent to the claims are intended to be encompassed therein.

### First Embodiment

Hereinafter, a first embodiment of a path restriction member and a wire harness will be described.

### Overall Configuration of Wire Harness 10

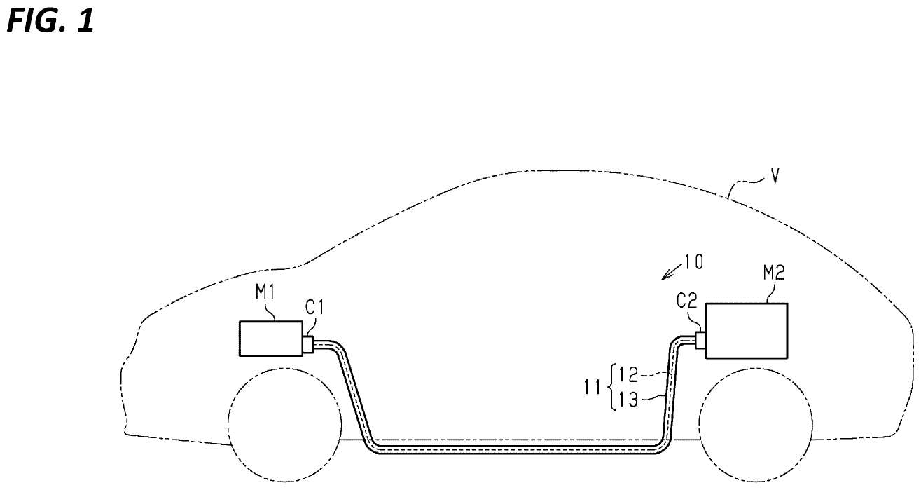

A wire harness 10 shown in FIG. 1 is mounted in a vehicle V such as a hybrid automobile or an electric automobile. The wire harness 10 electrically connects two or more electric devices to each other. The wire harness 10 electrically connects, for example, an inverter M1 installed at the front of the vehicle V and a high-voltage battery M2 installed rearward of the inverter 1 in the vehicle V. The wire harness 10 is routed in the vehicle V such that, for example, an intermediate portion in the axial direction (length direction) of the wire harness 10 passes outside the vehicle compartment of the vehicle V, such as under the floor of the vehicle V. The inverter M1 is connected, for example, to a wheel drive motor (not shown) that serves as a motive power source for vehicle travel. The inverter M1 generates AC power from the DC power of the high-voltage battery M2, and supplies the AC power to the motor. The high-voltage battery M2 is, for example, a battery capable of supplying a voltage of several hundred volts.

The wire harness 10 includes an electric wire member 11. The electric wire member 11 includes one or more electric wires 12 and a tubular exterior member 13 that surrounds the outer periphery of the electric wires 12. The wire harness 10 includes connectors C1 and C2 attached to both end portions in the length direction of the electric wire 12. A first end portion in the length direction of the electric wire 12 is connected to the inverter M1 via the connector C1, and a second end portion in the length direction of the electric wire 12 is connected to the high-voltage battery M2 via the connector C2.

The electric wire 12 is, for example, a thick electric wire having a large conductor cross-sectional area. Here, in this specification, a “thick electric wire” refers to an electric wire having a conductor cross-sectional area of 10 mm² (what is known as 10 sq) or more. The exterior member 13 has, for example, an elongated tubular shape as a whole. The exterior member 13 has a function of protecting the internal electric wire 12 from, for example, flying objects and water droplets. The exterior member 13 has, for example, flexibility and can be easily bent. Examples of the flexible exterior member 13 include a corrugated tube made of synthetic resin and a waterproof cover made of rubber.

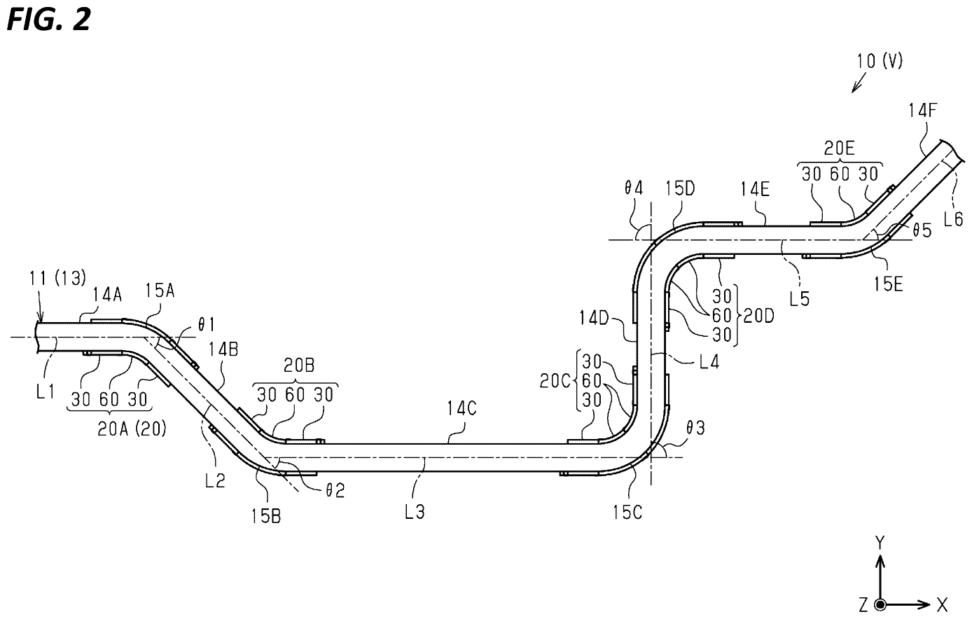

As shown in FIG. 2, when the electric wire member 11 is mounted in the vehicle V, for example, it is bent two-dimensionally or three-dimensionally. The electric wire member 11 of this embodiment has a straight portion 14A extending linearly along the X-axis direction, a bent portion 15A provided at an end portion of the straight portion 14A, and a straight portion 14B extending diagonally downward to the right in the drawing from the bent portion 15A. The electric wire member 11 of this embodiment has a bent portion 15B provided at an end portion of the straight portion 14B, a straight portion 14C extending linearly along the X-axis direction from the bent portion 15B, and a bent portion 15C provided at an end portion of the straight portion 14C. The electric wire member 11 of this embodiment has a straight portion 14D extending linearly along the Y-axis direction from the bent portion 15C, a bent portion 15D provided at an end portion of the straight portion 14D, and a straight portion 14E extending linearly along the X-axis direction from the bent portion 15D. The electric wire member 11 of this embodiment has a bent portion 15E provided at an end portion of the straight portion 14E, and a straight portion 14F extending diagonally upward to the right in the drawing from the bent portion 15E. In this manner, the electric wire member 11 of the present embodiment has five bent portions 15A, 15B, 15C, 15D, and 15E.

The bent portion 15A is formed, for example, so as to bend the path of the electric wire member 11 at a bending angle θ1. Here, the bending angle θ1 is the angle between a central axis L1 of the straight portion 14A and a central axis L2 of the straight portion 14B. The bent portion 15A bends the path of the electric wire member 11 such that the bending angle θ1 is 45°. The bent portion 15A is formed, for example, so as to bend the path of the electric wire member 11 to the right in the drawing with respect to the central axis L1 of the straight portion 14A. That is, the bent portion 15A is formed so as to bend the path of the electric wire member 11 to the right at a bending angle θ1 of 45° with respect to the central axis L1 of the straight portion 14A.

The bent portion 15B bends the path of the electric wire member 11 such that a bending angle θ2 between the central axis L2 of the straight portion 14B and a central axis L3 of the straight portion 14C is, for example, 45°. The bent portion 15B is formed, for example, so as to bend the path of the electric wire member 11 to the left in the drawing with respect to the central axis L2 of the straight portion 14B. That is, the bent portion 15B is formed so as to bend the path of the electric wire member 11 to the left at a bending angle θ2 of 45° with respect to the central axis L2 of the straight portion 14B. The bent portion 15C bends the path of the electric wire member 11 such that a bending angle θ3 between the central axis L3 of the straight portion 14C and a central axis LA of the straight portion 14D is 90°, for example. The bent portion 15C is formed, for example, so as to bend the path of the electric wire member 11 to the left at a bending angle θ3 of 90° with respect to the central axis L3 of the straight portion 14C. The bent portion 15D bends the path of the electric wire member 11 such that a bending angle θ4 between the central axis L4 of the straight portion 14D and a central axis LS of the straight portion 14E is, for example, 90°. The bent portion 15D is formed, for example, so as to bend the path of the electric wire member 11 to the right at a bending angle θ4 of 90° with respect to the central axis L4 of the straight portion 14D. The bent portion 15E bends the path of the electric wire member 11 such that a bending angle θ5 between the central axis L5 of the straight portion 14E and a central axis L6 of the straight portion 14F is, for example, 45°. The bent portion 15E is formed, for example, so as to bend the path of the electric wire member 11 to the left at a bending angle θ5 of 45° with respect to the central axis L5 of the straight portion 14E.

The wire harness 10 includes one or more path restriction members 20 that restrict the path of the electric wire member 11. The path restriction members 20 are attached to the outer periphery of the electric wire member 11. The path restriction members 20 are provided at at least one of the plurality of bent portions 15A, 15B, 15C, 15D, and 15E of the electric wire member 11, and maintain the bent shape of the electric wire member 11 at the bent portions 15A, 15B, 15C, 15D, and 15E. The wire harness 10 of the present embodiment includes five path restriction members 20A, 20B, 20C, 20D, and 20E. The five path restriction members 20A, 20B, 20C, 20D, and 20E are provided corresponding to the five bent portions 15A, 15B, 15C, 15D, and 15E, respectively.

### Configuration of Path Restriction Members 20A, 20B, 20C, 20D, and 20E

The plurality of path restriction members 20A, 20B, 20C, 20D, and 20E are provided, for example, spaced apart from each other in the length direction of the electric wire member 11. Each of the path restriction members 20A, 20B, 20C, 20D, and 20E includes, for example, one or more straight components 30 and one or more bent components 60. The path restriction members 20A, 20B, 20C, 20D, and 20E are set, for example, such that the combination of straight components 30 and bent components 60 differs according to the bent shapes of the corresponding curved portions 15A, 15B, 15C, 15D, and 15E. Here, the straight components 30 of the respective path restriction members 20A, 20B, 20C, 20D, and 20E have the same structure as each other, and the bent components 60 of the respective path restriction members 20A, 20B, 20C, 20D, and 20E have the same structure as each other.

### Configuration of Path Restriction Member 20A

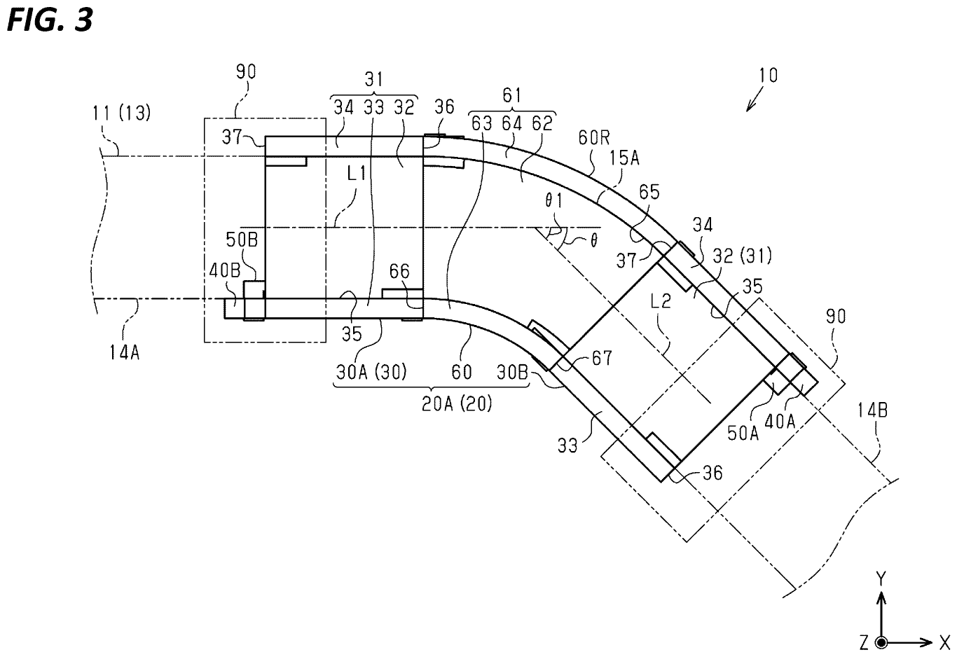

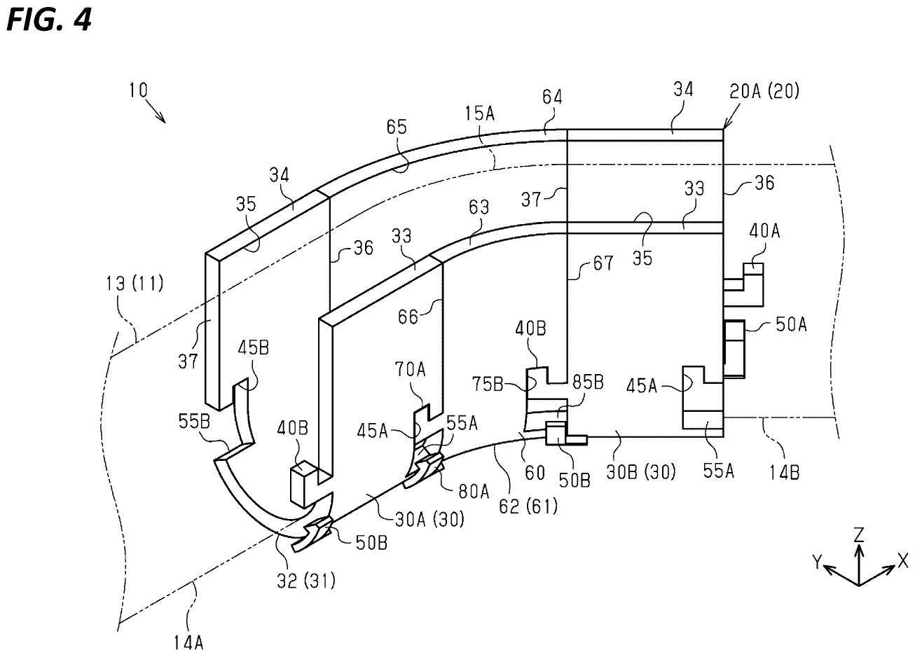

As shown in FIGS. 3 and 4, the path restriction member 20A is configured such that, along the length direction of the electric wire member 11, a straight component 30, a bent component 60, and a straight component 30 are arranged in the stated order. In the following description, for convenience, the straight component 30 located to the left of the bent component 60 in the drawing may be referred to as a “straight component 30A”, and the straight component 30 located to the right of the bent component 60 in the drawing may be referred to as a “straight component 30B”.

Each of the straight components 30A and 30B and the bent component 60 holds the exterior member 13. The exterior member 13 is less likely to bend than in a state where, for example, the straight components 30A and 30B and the bent component 60 are not attached. The straight components 30A and 30B and the bent component 60 are made of, for example, metal or resin. In this embodiment, the straight components 30A and 30B and the bent component 60 are made of resin. The straight components 30A and 30B and the bent component 60 can be made of a synthetic resin such as polypropylene, polyamide, or polyacetal. The straight components 30A and 30B and the bent component 60 may be made of mutually different materials or may be made of the same material as each other.

The straight component 30A is attached to the outer periphery of the exterior member 13 at the straight portion 14A of the path of the electric wire member 11, for example. The straight component 30B is attached to the outer periphery of the exterior member 13 at the straight portion 14B of the path of the electric wire member 11, for example. The straight components 30A and 30B restrict the path of the electric wire member 11 in the straight portions 14A and 14B, respectively. Each of the straight components 30A and 30B includes a holding portion 31 for holding the electric wire member 11.

The bent component 60 is attached to the outer periphery of the exterior member 13 at the bent portion 15A of the path of the electric wire member 11, for example. The bent component 60 restricts the path of the electric wire member 11 at the bent portion 15A. The bent component 60 has a holding portion 61 that holds the electric wire member 11.

### Configuration of Straight Components 30A and 30B

Next, a specific structure of the straight component 30A will be described. Note that since the straight component 30B has the same structure as the straight component 30A, configurations that are the same as those of the straight component 30A are denoted by the same reference numerals, and detailed description thereof is omitted here.

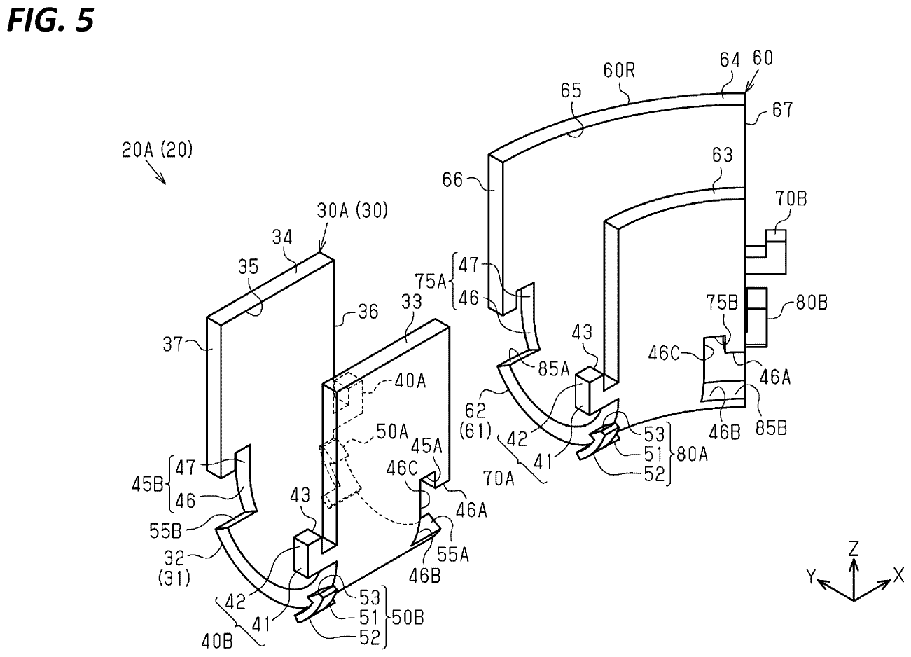

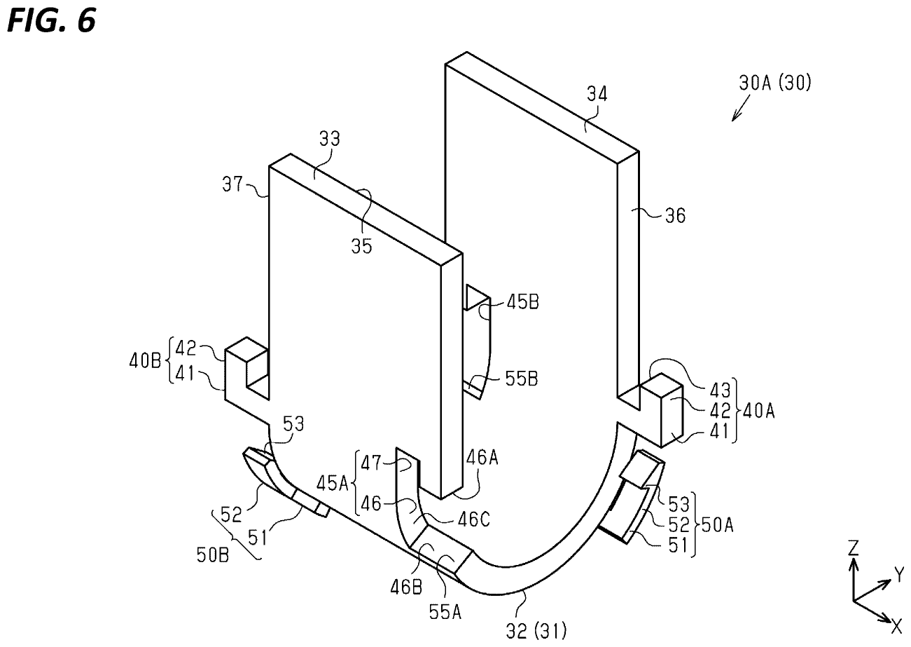

As shown in FIGS. 5 and 6, the straight component 30A of this embodiment includes a holding portion 31, two coupling portions 40A and 40B having the same structure as each other, and two coupling portions 45A and 45B having the same structure as each other. The straight component 30A of the present embodiment includes two engagement portions 50A and 50B having the same structure as each other, and two engagement portions 55A and 55B having the same structure as each other. The straight component 30A is formed, for example, in a shape that is point-symmetric with respect to a central axis of the straight component 30A that passes through the center of the straight component 30A in the XY plane and extends in the Z-axis direction. The straight component 30A is formed, for example, such that the planar shape as viewed from the Z-axis direction is point-symmetric with respect to the central axis of the straight component 30A extending in the Z-axis direction.

As shown in FIG. 4, the holding portion 31 has a tubular shape that covers the outer periphery of the exterior member 13 at a portion in the peripheral direction of the exterior member 13. The lateral cross-sectional shape of the holding portion 31 is U-shaped as a whole. The holding portion 31 is formed in a shape that extends linearly in one direction. That is, the axial direction of the tubular holding portion 31 extends linearly in one direction.

The holding portion 31 has, for example, a bottom wall 32 and two side walls 33 and 34 protruding from both side edges of the bottom wall 32. The bottom wall 32 extends linearly along the X-axis direction, for example. The lateral cross-sectional shape of the bottom wall 32 is, for example, arc-shaped.

Each of the side walls 33 and 34 is formed integrally and continuously with the bottom wall 32. The side walls 33 and 34 protrude, for example, along the Z-axis direction from both edges of the bottom wall 32 in the width direction (here, the Y-axis direction). The two side walls 33 and 34 oppose each other in the width direction of the bottom wall 32, for example. Each of the side walls 33 and 34 is formed, for example, in a plate shape. Each of the side walls 33 and 34 extends linearly along the Z-axis direction and extends linearly along the X-axis direction, for example. Each of the side walls 33 and 34 extends, for example, over the entire length in the length direction of the bottom wall 32.

As shown in FIG. 5, the straight component 30A has an insertion opening 35 that is open in a direction perpendicular to the axial direction of the straight component 30A. The insertion opening 35 is constituted by a gap between an upper end of the side wall 33 and an upper end of the side wall 34. The insertion opening 35 extends, for example, along the axial direction of the straight component 30A over the entire length in the axial direction of the straight component 30A. That is, the insertion opening 35 is formed so as to be open in a direction perpendicular to the axial direction of the straight component 30A and to be open at both ends in the axial direction of the straight component 30A.

The straight component 30A has an end portion 36 and an end portion 37 in the axial direction of the straight component 30A. The end portion 36 is, for example, the end portion opposing the bent component 60. The end portion 37 is an end portion provided on the opposite side to the end portion 36 in the axial direction of the straight component 30A.

As shown in FIG. 6, the coupling portion 40A is provided at the end portion 36 on the side wall 34. The coupling portion 40B is provided at the end portion 37 on the side wall 33. The two coupling portions 40A and 40B are provided at positions that are point-symmetrical to each other with respect to the central axis of the straight component 30A that extends parallel to the Z-axis direction, in a plan view from the Z-axis direction.

The coupling portion 45A is provided at the end portion 36 on the side wall 33. The coupling portion 45B is provided at the end portion 37 on the side wall 34. The two coupling portions 45A and 45B are provided at positions that are point-symmetrical to each other with respect to the central axis of the straight component 30A that extends parallel to the Z-axis direction, in a plan view from the Z-axis direction.

The two engagement portions 50A and 50B are provided at positions overlapping with the two coupling portions 40A and 40B in a plan view from the Z-axis direction. The two engagement portions 50A and 50B are provided at positions that are point-symmetrical to each other with respect to the central axis of the straight component 30A that extends parallel to the Z-axis direction in a plan view from the Z-axis direction.

The engagement portion 55A is provided at the end portion 36 on the side wall 33. The engagement portion 55B is provided at the end portion 37 on the side wall 34. The two engagement portions 55A and 55B are provided at positions overlapping with the two coupling portions 45A and 45B in a plan view from the Z-axis direction. The two engagement portions 55A and 55B are provided at positions that are point-symmetrical to each other with respect to the central axis of the straight component 30A that extends parallel to the Z-axis direction in a plan view from the Z-axis direction.

Next, a specific structure of the coupling portion 40A will be described. Note that since the coupling portion 40B has the same structure as the coupling portion 40A, configurations that are the same as those of the coupling portion 40A are denoted by the same reference numerals, and detailed description thereof will be omitted here.

The coupling portion 40A has a protruding portion 41 that protrudes along the axial direction of the holding portion 31 from the end portion 36 on the side wall 34, and an engaging projection 42 that protrudes along the height direction of the side wall 34 (here, the Z-axis direction) from the leading end of the protruding portion 41. The coupling portion 40A has the protruding portion 41 and the engaging projection 42, which are formed integrally and continuously with each other.

The protruding portion 41 is formed integrally and continuously with the side wall 34. The protruding portion 41 is provided, for example, at a portion in the height direction of the side wall 34. The protruding portion 41 is provided, for example, so as to be connected to the lower end portion of the side wall 34 at the end portion 36. The protruding portion 41 extends linearly, for example, along the axial direction of the straight component 30A (here, the X-axis direction). The protruding portion 41 is formed, for example, along the thickness direction of the side wall 34 (here, the Y-axis direction) over the entire length in the thickness direction of the side wall 34. The length of the protruding portion 41 along the Y-axis direction is equal to the length of the side wall 34 along the Y-axis direction, for example.

The engaging projection 42 protrudes along the Z-axis direction from the upper surface at the leading end of the protruding portion 41. The engaging projection 42 is provided, for example, at a portion in the length direction (here, the X-axis direction) of the protruding portion 41. The engaging projection 42 extends linearly along the height direction of the side wall 34, for example. In the coupling portion 40A, a recess 43 is formed by the side wall 34 at the end portion 36, the upper surface of the protruding portion 41, and a side surface of the engaging projection 42. The length of the engaging projection 42 along the Y-axis direction is equal to the length of the protruding portion 41 along the Y-axis direction, for example.

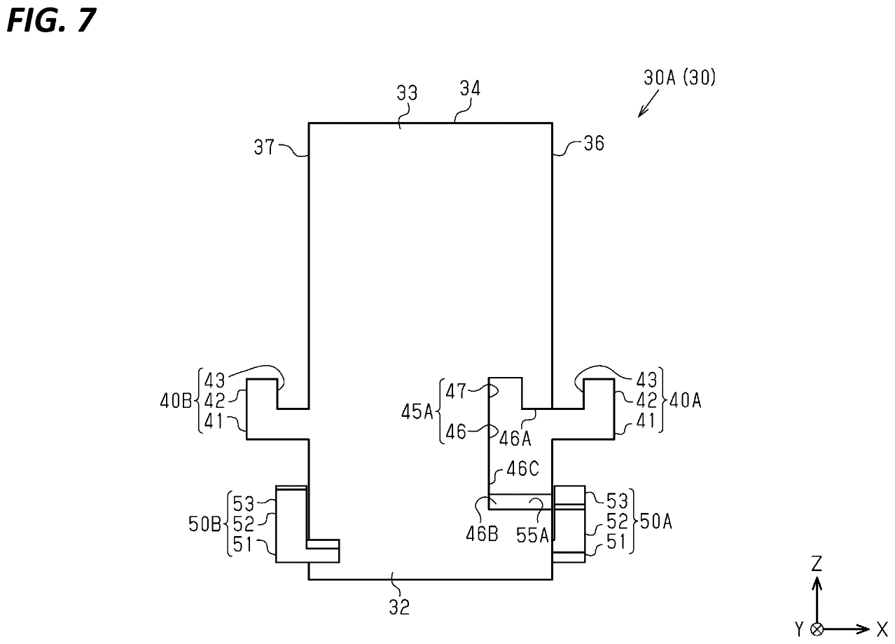

As shown in FIG. 7, the length of the engaging projection 42 along the axial direction of the straight component 30A, here the length of the engaging projection 42 along the X-axis direction, is equal to the length of the recess 43 along the X-axis direction, for example. The length of the engaging projection 42 along the X-axis direction is, for example, greater than the length of the side wall 34 along the thickness direction of the side wall 34 (here, the Y-axis direction). Note that the length of the engaging projection 42 along the X-axis direction may also be equal to or smaller than the length of the side wall 34 along the Y-axis direction.

Next, a specific structure of the coupling portion 45A will be described. Note that since the coupling portion 45B has the same structure as the coupling portion 45A, configurations that are the same as those of the coupling portion 45A are denoted by the same reference numerals, and detailed description thereof is omitted here.

he coupling portion 45 A has a first recess 46 recessed toward the end portion 37 from the end surface in the axial direction of the side wall 33 at the end portion 36. The first recess 46 is formed, for example, so as to extend from the lower end portion of the side wall 33 to a portion of the bottom wall 32 in the peripheral direction of the holding portion 31. The first recess 46 is formed, for example, so as to pass through the side wall 33 in the thickness direction (here, the Y-axis direction).

The first recess 46 has a first inner surface 46A, a second inner surface 46B, and a bottom surface 46C. The first inner surface 46A is provided above the second inner surface 46B in the Z-axis direction in the drawing. The first inner surface 46A is provided at the same position as the upper surface of the protruding portion 41 in the Z-axis direction, for example. The first inner surface 46A extends along the X-axis direction.

The second inner surface 46B is provided, for example, with a gap between it and the first inner surface 46A in the Z-axis direction, the gap being larger than the length of the protruding portion 41 along the Z-axis direction. As shown in FIG. 5, the second inner surface 46B is provided at a position where it can engage with an engagement portion 80A of the bent component 60 in the Z-axis direction, for example. The second inner surface 46B forms an engagement portion 55A that engages with the engagement portion 80A in the peripheral direction of the path restriction member 20A. As shown in FIG. 7, the second inner surface 46B extends along the X-axis direction. The bottom surface 46C extends, for example, along the Z-axis direction. The bottom surface 46C extends in the Z-axis direction from the first inner surface 46A to the second inner surface 46B.

The first recess 46 is formed to a size that the protruding portion 41 can fit in. The recess amount of the first recess 46, that is, the length of the first recess 46 along the X-axis direction, is equal to the length of the protruding portion 41 along the X-axis direction, for example.

The coupling portion 45A has a second recess 47 recessed upward in the drawing from the first inner surface 46A. The second recess 47 is formed, for example, to a size that the engaging projection 42 can fit in. The recess amount of the second recess 47, that is, the length of the second recess 47 along the Z-axis direction, is equal to the length of the engaging projection 42 along the Z-axis direction, for example. The length of the second recess 47 along the X-axis direction is equal to the length of the engaging projection 42 along the X-axis direction, for example.

Next, a specific structure of the engagement portion 50A will be described. Note that since the engagement portion 50B has the same structure as the engagement portion 50A, configurations that are the same as those of the engagement portion 50A are denoted by the same reference numerals, and detailed description thereof is omitted here. Note that the structure of the engagement portion 50A will be described with reference to the engagement portion 50B as well.

As shown in FIG. 6, the engagement portion 50A has a base portion 51 provided on the outer peripheral surface of the bottom wall 32, for example. The base portion 51 is, for example, formed integrally and continuously with the outer peripheral surface of the bottom wall 32. The base portion 51 is formed so as to protrude outward of the holding portion 31 from the outer peripheral surface of the bottom wall 32 along the axial direction of the holding portion 31. The base portion 51 is formed so as to protrude outward in the axial direction of the holding portion 31 relative to the end surface in the axial direction of the side wall 34.

The engagement portion 50A has an elastically deformable elastic piece 52 that protrudes from the leading end of the base portion 51 along the peripheral direction of the holding portion 31, and an engagement claw 53 provided at the protruding tip of the elastic piece 52. The elastic piece 52 is provided at a position spaced apart from the bottom wall 32 in the X-axis direction, for example. The elastic piece 52 is formed, for example, in a shape that follows the outer peripheral surface of the bottom wall 32. The shape of the elastic piece 52 in a view from the X-axis direction is, for example, an arc shape. The elastic piece 52 is provided so as not to overlap with the holding portion 31 in a plan view from, for example, the X-axis direction. The elastic piece 52 is formed, for example, in a cantilever shape, with a base end connected to the protruding tip of the base portion 51 serving as a fixed end and a leading end opposite to the base end serving as a free end. The length of the elastic piece 52 along the Y-axis direction is smaller than the length of the bottom wall 32 along the Y-axis direction. The elastic piece 52 is configured to be able to bend in the radial direction of the holding portion 31 by elastic deformation, for example.

The engagement claw 53 protrudes, for example, from the leading end of the elastic piece 52 along a direction intersecting with the peripheral direction of the holding portion 31. The engagement claw 53 is formed, for example, so as to protrude from the leading end of the elastic piece 52 toward the inside in the radial direction of the holding portion 31. The engagement claw 53 is provided so as to overlap with the holding portion 31 in a plan view from the X-axis direction.

Next, the specific structure of the engagement portions 55A and 55B will be described. The engagement portion 55A is formed by the second inner surface 46B of the first recess 46 of the coupling portion 45A. The engagement portion 55B is formed by the second inner surface 46B of the first recess 46 of the coupling portion 45B.

### Configuration of Bent Component 60

Next, the specific structure of the bent component 60 will be described.

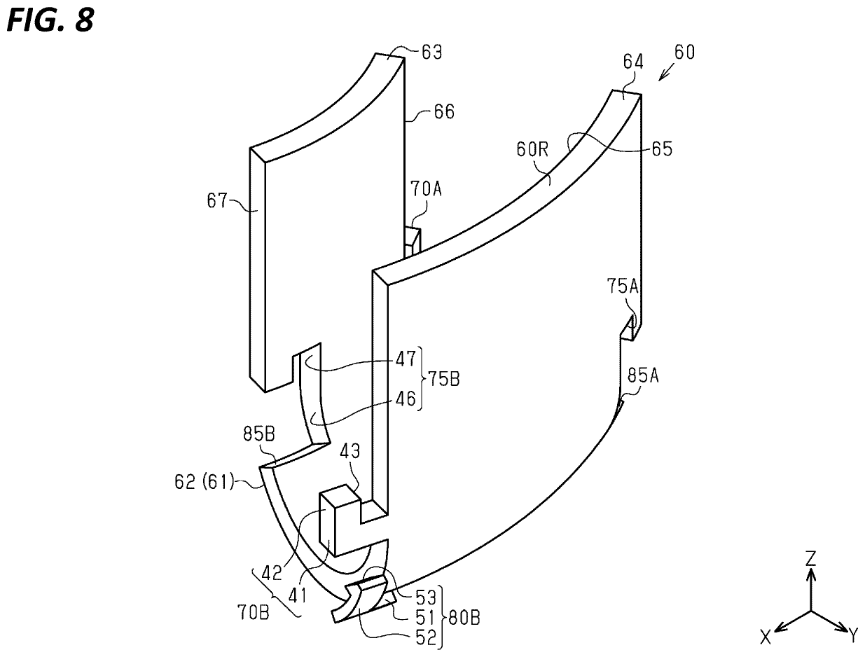

As shown in FIGS. 5 and 8, the bent component 60 of this embodiment includes a holding portion 61, two coupling portions 70A and 70B having the same structure as each other, and two coupling portions 75A and 75B having the same structure as each other. As shown in FIG. 5, the bent component 60 of this embodiment includes two engagement portions 80A and 80B having the same structure as each other, and two engagement portions 85A and 85B having the same structure as each other.

As shown in FIG. 4, the holding portion 61 has a tubular shape that covers the outer periphery of the exterior member 13 at a portion in the peripheral direction of the exterior member 13. The lateral cross-sectional shape of the holding portion 61 is U-shaped as a whole. As shown in FIG. 3, the holding portion 61 is formed in a bent shape having a bent portion 60R that is bent at a predetermined bending angle θ. In this embodiment, the bending angle θ of the bent portion 60R is set to 45°. The axial direction of the tubular holding portion 61 extends so as to bend at the predetermined bending angle θ.

The holding portion 61 has, for example, a bottom wall 62 and two side walls 63 and 64 protruding from both side edges of the bottom wall 62. The bottom wall 62 extends so as to bend at the predetermined bending angle θ in a plan view from the Z-axis direction, for example. The bottom wall 62 is formed so as to curve in an arc shape in a plan view from the Z-axis direction, for example. As shown in FIG. 5, the lateral cross-sectional shape of the bottom wall 62 is, for example, arc-shaped. The lateral cross-sectional shape of the bottom wall 62 is, for example, formed to be the same shape and size as the lateral cross-sectional shape of the bottom wall 32.

Each of the side walls 63 and 64 is formed integrally and continuously with the bottom wall 62. The side walls 63 and 64 protrude, for example, from both edges in the width direction (here, the Y-axis direction) of the bottom wall 62 along the Z-axis direction. The two side walls 63 and 64 oppose each other in the width direction of the bottom wall 62, for example. The length of the side walls 63 and 64 along the Z-axis direction is equal to the length of the side walls 33 and 34 along the Z-axis direction, for example.

As shown in FIG. 3, the side wall 63 is provided, for example, on the bend inner side of the bent portion 60R out of the two edges in the width direction of the bottom wall 62. The side wall 64 is provided, for example, on the bend outer side of the bent portion 60R out of the two edges in the width direction of the bottom wall 62. The inner and outer peripheral surfaces of the side walls 63 and 64 are formed so as to curve in an arc shape in a plan view from the Z-axis direction. The length of the side wall 63 along the axial direction of the holding portion 61 is smaller than the length of the side wall 64 along the axial direction of the holding portion 61.

As shown in FIG. 5, the bent component 60 has an insertion opening 65 that is open in a direction perpendicular to the axial direction of the bent component 60. The insertion opening 65 is constituted by a gap between an upper end of the side wall 63 and an upper end of the side wall 64. The insertion opening 65 extends, for example, along the axial direction of the bent component 60 over the entire length in the axial direction of the bent component 60. That is, the insertion opening 65 is formed so as to be open in a direction perpendicular to the axial direction of the bent component 60 and to be open at both ends in the axial direction of the bent component 60.

The bent component 60 has an end portion 66 and an end portion 67 in the axial direction of the bent component 60. The end portion 66 is, for example, an end portion opposing the end portion 36 of the straight component 30A. The end portion 67 is an end portion provided on the opposite side to the end portion 66 in the axial direction of the bent component 60. The end portion 67 is, for example, an end portion opposing the end portion 37 of the straight component 30B (see FIG. 3).

The coupling portion 70A is provided at the end portion 66 on the side wall 63. The coupling portion 70B is provided at the end portion 67 on the side wall 64. The coupling portion 75A is provided at the end portion 66 on the side wall 64. The coupling portion 75B is provided at the end portion 67 on the side wall 63. At the end portion 66 of the bent component 60, the coupling portion 70A is provided in the side wall 63 and the coupling portion 75A is provided in the side wall 64. On the other hand, at the end portion 67 of the bent component 60, the coupling portion 70B having the same structure as the coupling portion 70A is provided on the side wall 64, and the coupling portion 75B having the same structure as the coupling portion 75A is provided on the side wall 63. In this manner, the coupling portions 70B and 75B provided at the end portion 67 are formed to have a structure that is a 180-degree rotation of the structure of the coupling portions 70A and 75A provided at the end portion 66.

The two engagement portions 80A and 80B are provided at positions overlapping with the two coupling portions 70A and 70B, respectively, in a plan view from the Z-axis direction. The two engagement portions 85A and 85B are provided at positions overlapping with the two coupling portions 75A and 75B, respectively, in a plan view from the Z-axis direction. The engagement portions 80B and 85B provided at the end portion 67 are formed to have a structure that is a 180-degree rotation of the engagement portions 80A and 85A provided at the end portion 66.

Here, each of the two coupling portions 70A and 70B has the same structure as the coupling portion 40A of the straight component 30A. That is, each of the two coupling portions 70A and 70B has a protruding portion 41, an engaging projection 42, and a recess 43. Each of the two coupling portions 75A and 75B has the same structure as the coupling portion 45A of the straight component 30A. That is, each of the two coupling portions 75A and 75B has a first recess 46 and a second recess 47. The two engagement portions 80A and 80B have the same structure as the engagement portion 50A of the straight component 30A. That is, each of the two engagement portions 80A and 80B has a base portion 51, an elastic piece 52, and an engagement claw 53. The two engagement portions 85A and 85B have the same structure as the engagement portion 55A of the straight component 30A. That is, the two engagement portions 85A and 85B are constituted by the second inner surfaces 46B of the first recesses 46 that the coupling portions 75A and 75B have, respectively. Here, detailed description of the structures of the coupling portions 70A and 70B, the coupling portions 75A and 75B, the engagement portions 80A and 80B, and the engagement portions 85A and 85B is omitted.

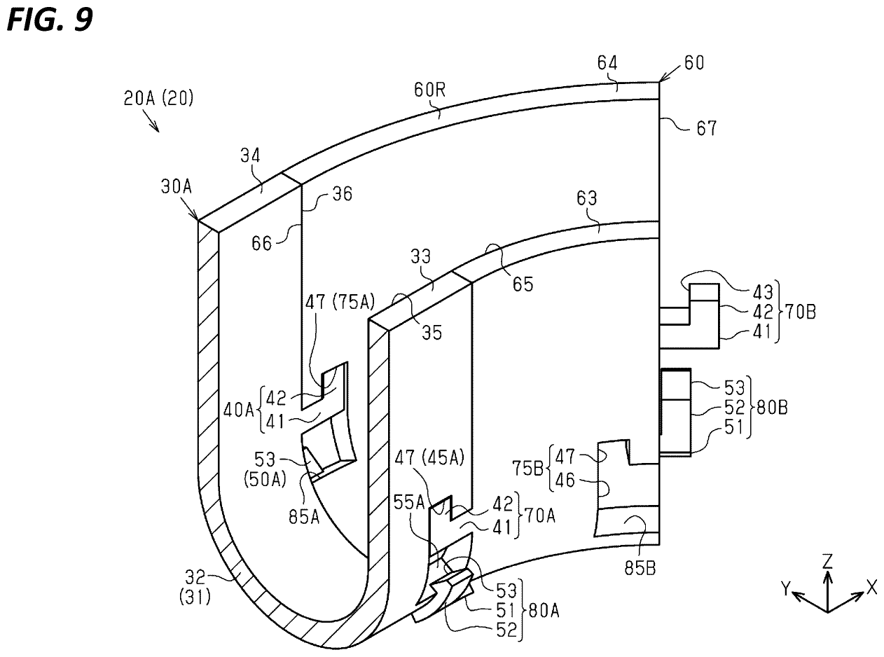

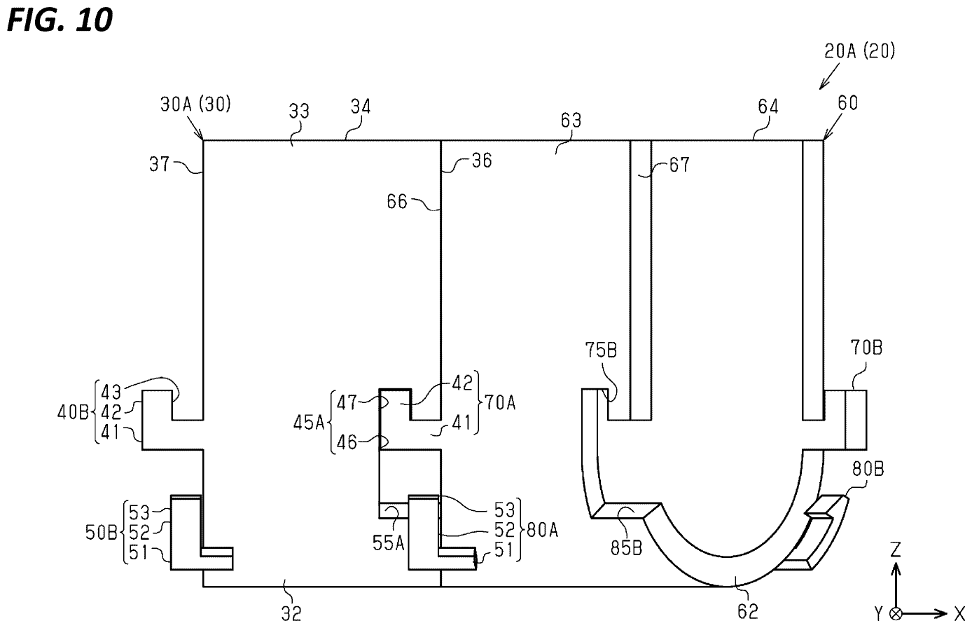

As shown in FIGS. 4, 9, and 10, the straight component 30A is coupled to the end portion 66 in the axial direction of the bent component 60. More specifically, as shown in FIG. 9, the coupling portion 40A of the straight component 30A and the coupling portion 75A of the bent component 60 are coupled to each other. Specifically, the protruding portion 41 of the coupling portion 40A is fitted into the first recess 46 of the coupling portion 75A, and the engaging projection 42 of the coupling portion 40A is fitted into the second recess 47 of the coupling portion 75A. The side surface of the engaging projection 42 of the coupling portion 40A and the inner surface of the second recess 47 of the coupling portion 75A are engaged with each other in the axial direction of the path restriction member 20A. As shown in FIGS. 9 and 10, the coupling portion 45A of the straight component 30A and the coupling portion 70A of the bent component 60 are coupled to each other. Specifically, the protruding portion 41 of the coupling portion 70A is fitted into the first recess 46 of the coupling portion 45A, and the engaging projection 42 of the coupling portion 70A is fitted into the second recess 47 of the coupling portion 45A. Also, the side surface of the engaging projection 42 of the coupling portion 70A and the inner surface of the second recess 47 of the coupling portion 45A are engaged with each other in the axial direction of the path restriction member 20A. These features make it possible to suitably suppress movement of the bent component 60 relative to the straight component 30A in the axial direction of the path restriction member 20A (the horizontal direction in the drawing). Furthermore, as shown in FIG. 9, the engagement claw 53 of the engagement portion 50A of the straight component 30A and the engagement portion 85A of the bent component 60 are engaged with each other in the peripheral direction of the path restriction member 20A. The engagement portion 50A and the engagement portion 85A are engaged with each other, for example, by a snap-fit method that utilizes the elastic deformation of the elastic piece 52 of the engagement portion 50A. In addition, the engagement claw 53 of the engagement portion 80A of the bent component 60 and the engagement portion 55A of the straight component 30A are engaged with each other in the peripheral direction of the path restriction member 20A. The engagement portion 55A and the engagement portion 80A are engaged with each other, for example, by a snap-fit method that utilizes elastic deformation of the elastic piece 52 of the engagement portion 80A. As a result, it is possible to suitably suppress relative movement of the bent component 60 relative to the straight component 30A in the peripheral direction of the path restriction member 20A.

As shown in FIG. 4, the straight component 30B is coupled to the end portion 67 of the bent component 60 in the same manner as the straight component 30A.

Here, in the path restriction member 20A in which the straight components 30A and 30B and the bent component 60 are coupled to each other, the insertion opening 35 of the straight component 30A, the insertion opening 65 of the bent component 60, and the insertion opening 35 of the straight component 30B are in communication with each other.

At a first end portion in the axial direction of the path restriction member 20A, the coupling portion 40B and the engagement portion 50B are provided so as to protrude outward relative to the holding portion 31 at the end portion 37 of the straight component 30A. In addition, at a second end portion in the axial direction of the path restriction member 20A, the coupling portion 40A and the engagement portion 50A are provided so as to protrude outward relative to the holding portion 31 at the end portion 36 of the straight component 30B.

As shown in FIG. 3, the wire harness 10 includes a slide restriction member 90 that restricts sliding movement of the path restriction member 20A in the length direction of the exterior member 13, for example. As the slide restriction member 90, for example, a cable tie made of resin or metal, a crimping ring, or an adhesive tape can be used. The slide restriction member 90 in this embodiment is an adhesive tape. The slide restriction members 90 are provided at a first end portion and a second end portion in the axial direction of the path restriction member 20A. The slide restriction member 90 provided at the first end portion of the path restriction member 20A is wrapped around the outer peripheral surface of the end portion 37 of the straight component 30A and the outer peripheral surface of the exterior member 13, for example. The slide restriction member 90 provided at the second end portion of the path restriction member 20A is wrapped around the outer peripheral surface of the end portion 36 of the straight component 30B and the outer peripheral surface of the exterior member 13, for example. Note that, although not shown in the drawings, the slide restriction members 90 are also provided for the path restriction members 20B, 20C, 20D, and 20E shown in FIG. 2.

### Configuration of Path Restriction Member 20B

As shown in FIG. 2, the path restriction member 20B is configured such that, along the length direction of the electric wire member 11, a straight component 30, a bent component 60, and a straight component 30 are arranged in this order. The straight components 30 and the bent component 60 in the path restriction member 20B have the same configurations as the straight components 30 and the bent component 60 in the path restriction member 20A, respectively. However, the path restriction member 20B is disposed such that the structure of the path restriction member 20A is rotated by 180 degrees. In other words, the bent components 60 can be used in common for the bent portion 15A, which is a right bent portion, and the bent portion 15B, which is a left bent portion. That is, the bent components 60 having the same configuration can be used in common for the bent portion 15A that is the right bent portion and the bent portion 15B that is the left bent portion.

### Configuration of Path Restriction Member 20D

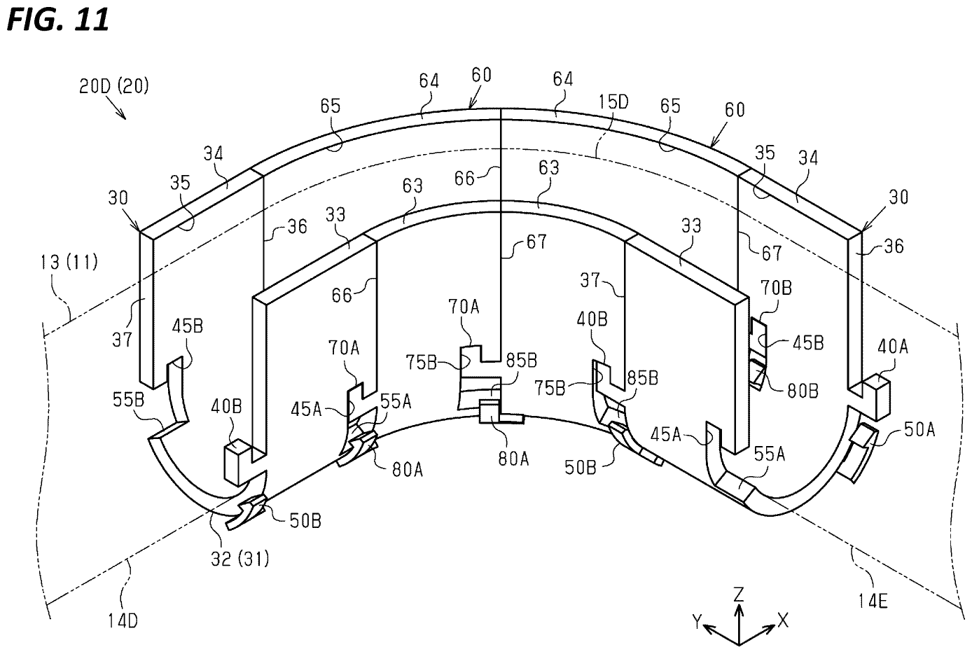

As shown in FIG. 11, the path restriction member 20D is configured such that, along the length direction of the electric wire member 11, a straight component 30, a bent component 60, a bent component 60, and a straight component 30 are arranged in this order. The straight components 30 and the bent components 60 in the path restriction member 20D have the same configurations as the straight components 30 and the bent component 60 in the path restriction member 20A, respectively. The coupling between the two bent components 60 can be performed in the same manner as the coupling between the straight component 30 and the bent component 60. The two bent components 60 are coupled in a state in which, for example, the end portion 66 of one bent component 60 (first bent component) and the end portion 67 of one bent component 60 (second bent component) oppose each other. For example, the coupling portions 70A and 75A at the end portion 66 of one bent component 60 and the coupling portions 75B and 70B at the end portion 67 of one bent component 60 are respectively coupled to each other. For example, the engagement portions 80A and 85A at the end portion 66 of one bent component 60 and the engagement portions 85B and 80B at the end portion 67 of one bent component 60 are respectively engaged with each other. As shown in FIG. 2, in the path restriction member 20D provided for the bent portion 15D having a bending angle θ4 of 90°, two bent components 60 are connected in series to adjust the bending angle of the path restriction member 20D. That is, in the path restriction member 20, the bending angle in the path restriction member 20 can be adjusted by adjusting the number of bent components 60 that are directly coupled to each other.

### Configuration of Path Restriction Member 20c

The path restriction member 20C is configured such that a straight component 30, a bent component 60, a bent component 60, and a straight component 30 are arranged in this order along the length direction of the electric wire member 11. The straight components 30 and the bent components 60 in the path restriction member 20C have the same configurations as the straight components 30 and the bent components 60 in the path restriction member 20D, respectively. However, the path restriction member 20C is disposed such that the structure of the path restriction member 20D is rotated by 180 degrees.

### Configuration of Path Restriction Member 20E

The path restriction member 20E is configured such that a straight component 30, a bent component 60, and a straight component 30 are arranged in this order along the length direction of the electric wire member 11. The straight components 30 and the bent component 60 in the path restriction member 20E have the same configurations as the straight components 30 and the bent components 60 in the path restriction member 20A, respectively. However, the path restriction member 20E is disposed such that the structure of the path restriction member 20A is rotated 135° clockwise.

### Method for Manufacturing Path Restriction Member 20A

Next, a method for manufacturing the path restriction member 20A will be described.

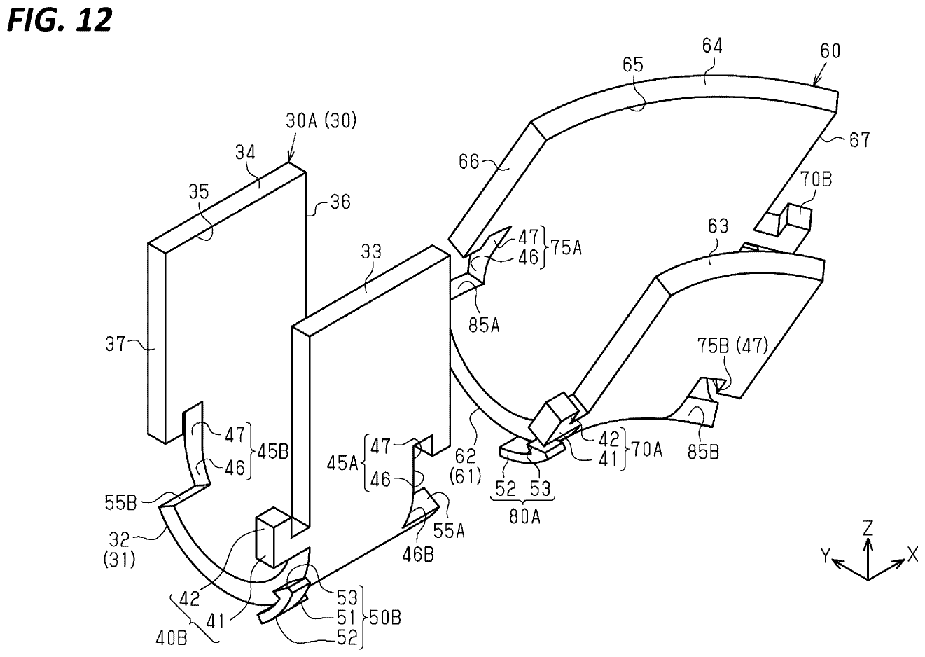

First, in a step shown in FIG. 12, the straight component 30A and the bent component 60 are prepared, and the bent component 60 is disposed such that the end portion 66 opposes the end portion 36 of the straight component 30A. Next, the bent component 60 is disposed so as to be inclined with respect to the axial direction of the straight component 30A

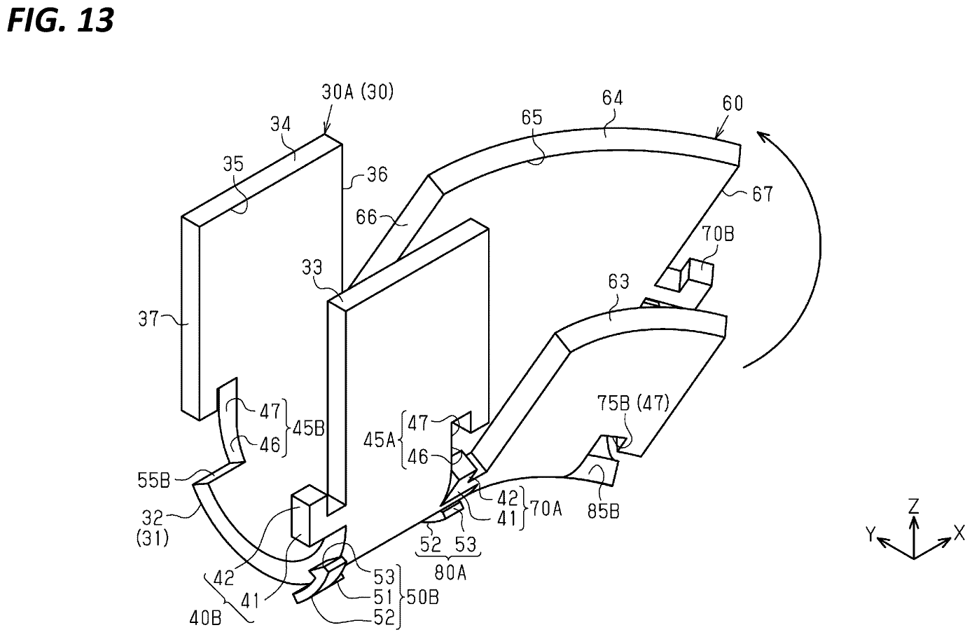

Next, in a step shown in FIG. 13, with the bent component 60 kept in the inclined state, the coupling portion 70A of the bent component 60 is inserted into the first recess 46 of the coupling portion 45A of the straight component 30A. At this time, the elastic piece 52 of the engagement portion 80A of the bent component 60 is elastically deformed so as to bend radially outward from the holding portion 61 due to the engagement claw 53 provided at the leading end of the elastic piece 52 coming into contact with the outer peripheral surface of the bottom wall 32 of the straight component 30A.

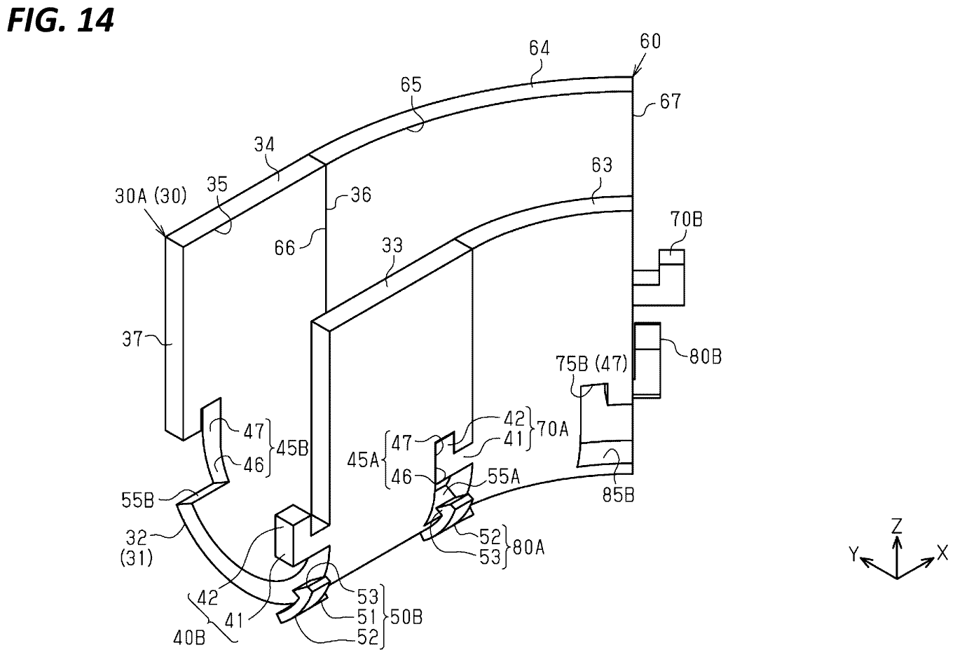

Next, the bent component 60 is rotated in the direction of the arrow in the drawing. Upon doing so, the bent component 60 rotates relative to the straight component 30A while the elastic piece 52 of the engagement portion 80A of the bent component 60 remains in the elastically deformed state. Thereafter, as shown in FIG. 14, when the engagement claw 53 of the engagement portion 80A passes over the engagement portion 55A of the straight component 30A, the elastic piece 52 of the engagement portion 80A elastically returns to its original shape. As a result, the engagement claw 53 of the engagement portion 80A is engaged with the engagement portion 55A of the straight component 30A. At this time, the engaging projection 42 of the coupling portion 70A of the bent component 60 is fitted into the second recess 47 of the coupling portion 45A of the straight component 30A. Through the above steps, the bent component 60 is coupled to the straight component 30A.

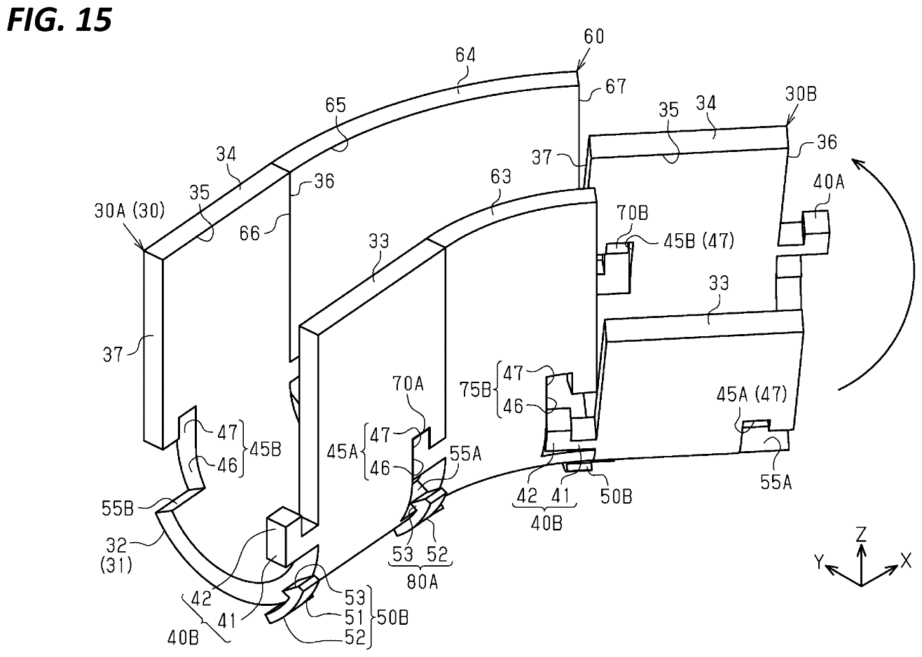

Next, in the step shown in FIG. 15, the straight component 30B is coupled to the end portion 67 of the bent component 60. More specifically, the straight component 30B is disposed such that the end portion 37 opposes the end portion 67 of the bent component 60. At this time, the straight component 30B is disposed so as to be inclined with respect to the axial direction of the bent component 60. Then, the coupling portion 40B of the straight component 30B is inserted into the first recess 46 of the coupling portion 75B of the bent component 60 while the straight component 30B remains inclined. Thereafter, by rotating the straight component 30B in the direction of the arrow in the drawing, the straight component 30B can be coupled to the bent component 60 in the same manner as the coupling between the straight component 30A and the bent component 60.

Through the above steps, the path restriction member 20A shown in FIG. 4 can be manufactured.

Next, the actions and effects of this embodiment will be described.

(1-1) The path restriction member 20 includes the bent component 60 including the holding portion 61 that holds the electric wire member 11 and has the bent portion 60R, the two coupling portions 70A and 70B having the same structure as each other, and the two coupling portions 75A and 75B having the same structure as each other. The path restriction member 20 includes the straight component 30 including the holding portion 31 that holds the electric wire member 11, the coupling portion 40A that is coupled to the coupling portion 75A, and the coupling portion 45A that is coupled to the coupling portion 70A. The holding portion 61 has the bottom wall 62 and the side walls 63 and 64 protruding from both side edges of the bottom wall 62. The bent component 60 has the end portions 66 and 67 in the axial direction of the bent component 60. The coupling portion 70A is provided at the end portion 66 on the side wall 63. The coupling portion 75A is provided at the end portion 36 on the side wall 64. The coupling portion 70B is provided at the end portion 67 on the side wall 64. The coupling portion 75B is provided at the end portion 67 on the side wall 63.

According to this configuration, at the end portion 66 of the bent component 60, the coupling portion 70A is provided in the side wall 63, and the coupling portion 75A is provided in the side wall 64. On the other hand, at the end portion 67 of the bent component 60, the coupling portion 70B having the same structure as the coupling portion 70A is provided in the side wall 64, and the coupling portion 75B having the same structure as the coupling portion 75A is provided in the side wall 63. In this manner, the coupling portions 70B and 75B at the end portion 67 of the bent component 60 are formed to have a structure that is a 180-degree rotation of the structure of the coupling portions 70A and 75A at the end portion 66 of the bent component 60. For this reason, the straight component 30 can be coupled to the end portion 66 of the bent component 60 and to the end portion 67 of the bent component 60. That is, the straight component 30 can be coupled to either the end portion 66 or the end portion 67 of the bent component 60. As a result, by appropriately changing the coupling direction of the straight component 30 with respect to the bent component 60 according to the path of the electric wire member 11, the bent components 60 having the same configuration and the straight components 30 having the same configuration can be used in common for two or more types of bent paths. Accordingly, compared to the conventional method in which a path restriction member with a different shape needs to be prepared for each bent path, the versatility of the path restriction member 20 can be improved.

(1-2) At the end portion 36 of the straight component 30, the coupling portion 40A is provided on the side wall 34, and the coupling portion 45A is provided on the side wall 33. On the other hand, at the end portion 37 of the straight component 30, the coupling portion 40B having the same structure as the coupling portion 40A is provided on the side wall 33, and the coupling portion 45B having the same structure as the coupling portion 45A is provided on the side wall 34. In this manner, the coupling portions 40B and 45B at the end portion 37 of the straight component 30 are formed to have a structure that is a 180-degree rotation of the coupling portions 40A and 45A at the end portion 36 of the straight component 30. For this reason, the bent component 60 can be coupled to either the end portion 36 or the end portion 37 of the straight component 30. As a result, by appropriately changing the coupling direction of the bent component 60 with respect to the straight component 30 according to the path of the electric wire member 11, the bent components 60 having the same configuration and the straight components 30 having the same configuration can be used in common for two or more types of bent paths. Accordingly, compared to the conventional method in which a path restriction member with a different shape needs to be prepared for each bent path, the versatility of the path restriction member 20 can be improved.

(1-3) The coupling portions 40A and 40B have the same structure as the coupling portion 70A, and the coupling portions 45A and 45B have the same structure as the coupling portion 75A. For this reason, the coupling portion 70A of another bent component 60 can be coupled to the coupling portion 75A that can be coupled to the coupling portion 40A. In addition, the coupling portion 75A of the other bent component 60 can be coupled to the coupling portion 70A that can be coupled to the coupling portion 45A. This allows the two bent components 60 to be directly coupled to each other. Similarly, the two straight components 30 can be directly coupled to each other. Accordingly, the degree of freedom in combining the straight components 30 and the bent components 60 in the path restriction member 20 can be improved. Furthermore, by changing the combination of the straight components 30 and the bent components 60, it is possible to form a path restriction member 20 that is compatible with various bent paths while using straight components 30 of the same configuration and bent components 60 of the same configuration. For example, the bending angle of the path restriction member 20 can be changed by changing the number of directly-coupled bent components 60. As a result, it is possible to form a path restriction member 20 that is compatible with various bent paths while suppressing an increase in the number of types of parts that constitute the path restriction member 20. As a result, the versatility of the straight components 30 and the bent components 60 can be improved.

(1-4) When the coupling portion 70A of the bent component 60 is coupled to the coupling portion 45A of the straight component 30, the side surface of the engaging projection 42 of the coupling portion 70A and the inner surface of the second recess 47 of the coupling portion 45A are engaged with each other in the axial direction of the path restriction member 20. In addition, when the coupling portion 75A of the bent component 60 is coupled to the coupling portion 40A of the straight component 30, the inner surface of the second recess 47 of the coupling portion 75A and the engaging projection 42 of the coupling portion 40A are engaged with each other in the axial direction of the path restriction member 20. As a result, it is possible to suitably suppress movement of the straight component 30 relative to the bent component 60 in the axial direction of the path restriction member 20.

(1-5) The length of the engaging projection 42 along the axial direction of the path restriction member 20, that is, the length of the engaging projection 42 along the direction in which it engages with the inner surface of the second recess 47, is formed to be larger than the length of the side wall 63 along the thickness direction of the side wall 63. For this reason, even if an external force that causes the side surface of the engaging projection 42 and the inner surface of the second recess 47 to press against each other is applied in the above-described axial direction from the electric wire member 11 or the like to the path restriction member 20, for example, it is possible to preferably suppress damage to the engaging projection 42 caused by the external force.

(1-6) The engagement portion 80A of the bent component 60 and the engagement portion 55A of the straight component 30 are engaged with each other in the peripheral direction of the path restriction member 20. Also, the engagement portion 85A of the bent component 60 and the engagement portion 50A of the straight component 30 are engaged with each other in the peripheral direction of the path restriction member 20. This makes it possible to suitably suppress movement of the straight component 30 relative to the bent component 60 in the peripheral direction of the path restriction member 20.

(1-7) The end portion 66 of the bent component 60 is provided with the engagement portion 80A and the engagement portion 85A. In addition, the end portion 67 of the bent component 60 is provided with the engagement portion 80B having the same structure as the engagement portion 80A, and the engagement portion 85B having the same structure as the engagement portion 85A. For this reason, when the straight component 30 is coupled to the end portion 67 of the bent component 60, the engagement portion 80B of the bent component 60 and the engagement portion 55A of the straight component 30 can be engaged with each other, and the engagement portion 85B of the bent component 60 and the engagement portion 50A of the straight component 30 can be engaged with each other. As a result, even when the straight component 30 is coupled to the end portion 67 of the bent component 60, it is possible to suitably suppress movement of the straight component 30 relative to the bent component 60 in the peripheral direction of the path restriction member 20.

(1-8) The engagement portion 80A includes the base portion 51 that protrudes outward of the holding portion 61 from the outer peripheral surface of the holding portion 61 along the axial direction of the holding portion 61, the elastic piece 52 that protrudes from the leading end of the base portion 51 along the peripheral direction of the holding portion 61, and the engagement claw 53 provided at the leading end of the elastic piece 52. According to this configuration, the engagement claw 53 of the engagement portion 80A and the engagement portion 55A can be suitably engaged with each other by a snap-fit method utilizing the elastic deformation of the elastic piece 52 of the engagement portion 80A. By engaging the engagement claw 53 of the engagement portion 80A with the engagement portion 55A, it is possible to suitably suppress movement of the straight component 30 relative to the bent component 60 in the peripheral direction of the path restriction member 20.

(1-9) In the path restriction member 20, the insertion opening 35 that opens in a direction perpendicular to the axial direction of the straight component 30 and the insertion opening 65 that opens in a direction perpendicular to the axial direction of the bent component 60 are in communication with each other. This makes it possible to attach the path restriction member 20 to the electric wire member 11 through the insertion openings 35 and 65 after terminal processing such as attaching the connectors C1 and C2 to the end portions in the axial direction of the electric wire member 11 has been performed. In this manner, since the path restriction member 20 can be retrofitted to the electric wire member 11, the assembly workability of the wire harness 10 can be improved.

### Modified Example of First Embodiment

The first embodiment can be modified and implemented as follows. The first embodiment and the following modified examples can be implemented in combination with each other to the extent that no technical contradiction occurs.

The structure of the path restriction member 20 in the first embodiment can be modified as appropriate. For example, by modifying the combination of the straight components 30 and the bent components 60, that is, the numbers and the coupling directions of the straight components 30 and the bent components 60, the path restriction member 20 can be formed into various structures. The numbers of the straight components 30 and the bent components 60 that are included in the path restriction member 20 are not particularly limited. For example, the path restriction member 20 may include only two or more bent components 60.

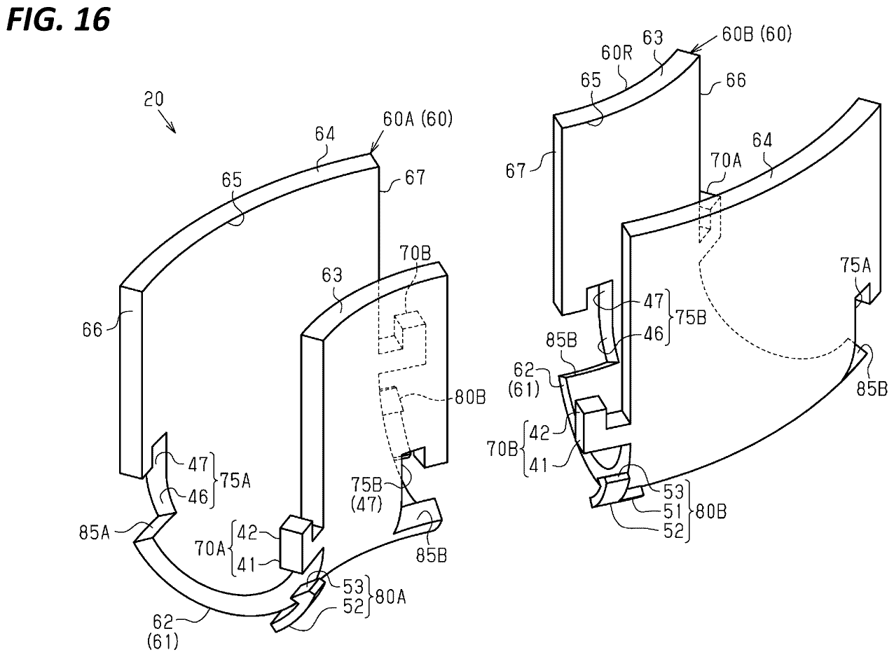

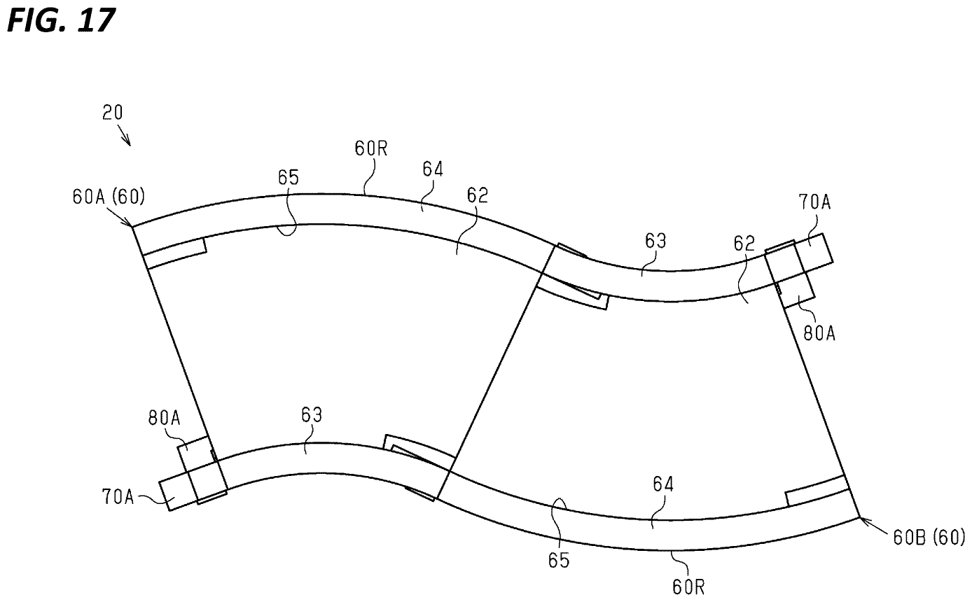

For example, as shown in FIGS. 16 and 17, the path restriction member 20 may be formed by coupling two bent components 60A and 60B. Here, each of the bent components 60A and 60B has the same structure as the bent component 60 shown in FIG. 5 or the like. The bent component 60B is disposed, for example, in a state where the structure of the bent component 60A is rotated 180 degrees. As shown in FIG. 16, the bent component 60A and the bent component 60B are coupled to each other with the end portion 67 of the bent component 60A and the end portion 67 of the bent component 60B opposing each other. For example, the coupling portion 75B provided at the end portion 67 of the side wall 63 of the bent component 60A is coupled to the coupling portion 70B provided at the end portion 67 of the side wall 64 of the bent component 60B. In addition, the coupling portion 70B provided at the end portion 67 of the side wall 64 of the bent component 60A is coupled to the coupling portion 75B provided at the end portion 67 of the side wall 63 of the bent component 60B.

As shown in FIG. 17, the path restriction member 20 of this modified example is formed in a shape in which a right bent portion and a left bent portion are continuous with each other along the axial direction of the path restriction member 20 in a plan view from the Z-axis direction.

In the first embodiment, the path restriction members 20 are provided at only the bent portions 15A, 15B, 15C, 15D, and 15E of the routing path of the electric wire member 11, but there is no limitation to this. For example, the path restriction members 20 may also be provided for the straight portions 14A, 14B, 14C, 14D, 14E, and 14F. For example, the path restriction member 20 may be provided at the straight portion 14C provided between the path restriction member 20B and the path restriction member 20C. For example, a straight component 30 that is coupled to both of the path restriction members 20C and 20D may be provided for the straight portion 14D that is provided between the path restriction members 20C and 20D. In this case, the path restriction member 20C and the path restriction member 20D are formed in one piece by the straight component 30 provided at the straight portion 14D. In this case, the planar shape of the path restriction members 20C and 20D is formed into an S shape

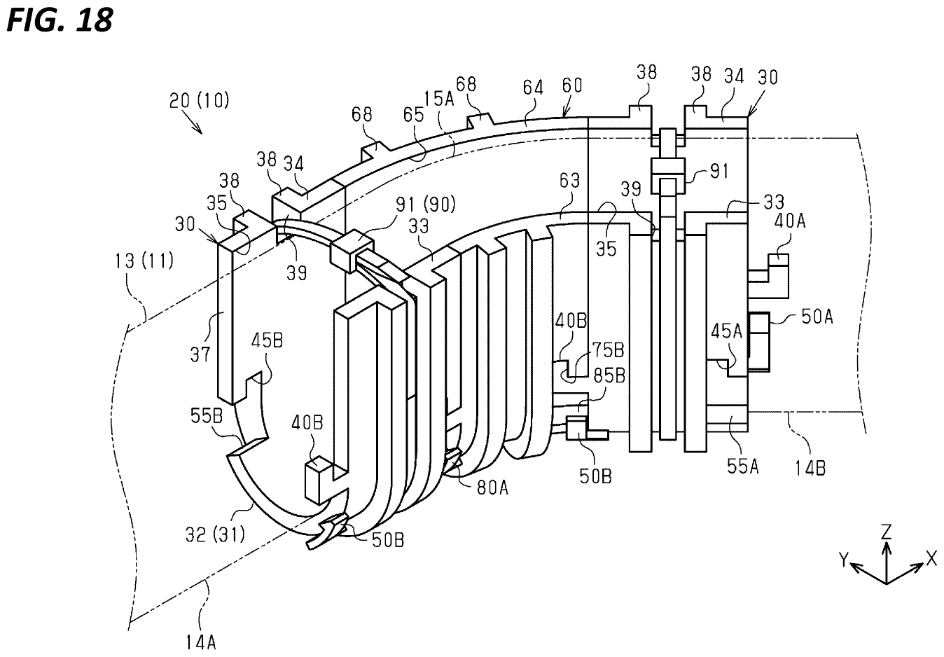

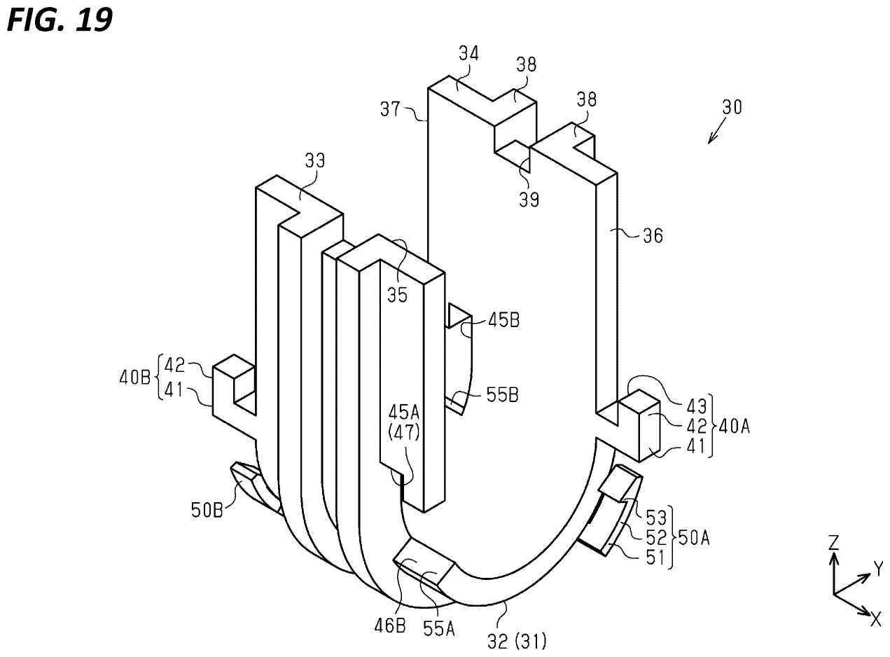

For example, as shown in FIGS. 18 and 19, the outer peripheral surface of the straight component 30 may be provided with one or more reinforcing ribs 38. The straight component 30 of this modified example has two reinforcing ribs 38. Each reinforcing rib 38 is formed, for example, over the entire periphery in the peripheral direction of the outer peripheral surface of the holding portion 31. Each reinforcing rib 38 is formed, for example, so as to extend continuously to the outer peripheral surface of the side wall 33, the outer peripheral surface of the bottom wall 32, and the outer peripheral surface of the side wall 34. Each reinforcing rib 38 is formed so as to protrude radially outward of the holding portion 31 from the outer peripheral surface of the holding portion 31. According to this configuration, by providing the reinforcing ribs 38, the bending rigidity of the straight component 30 can be improved.

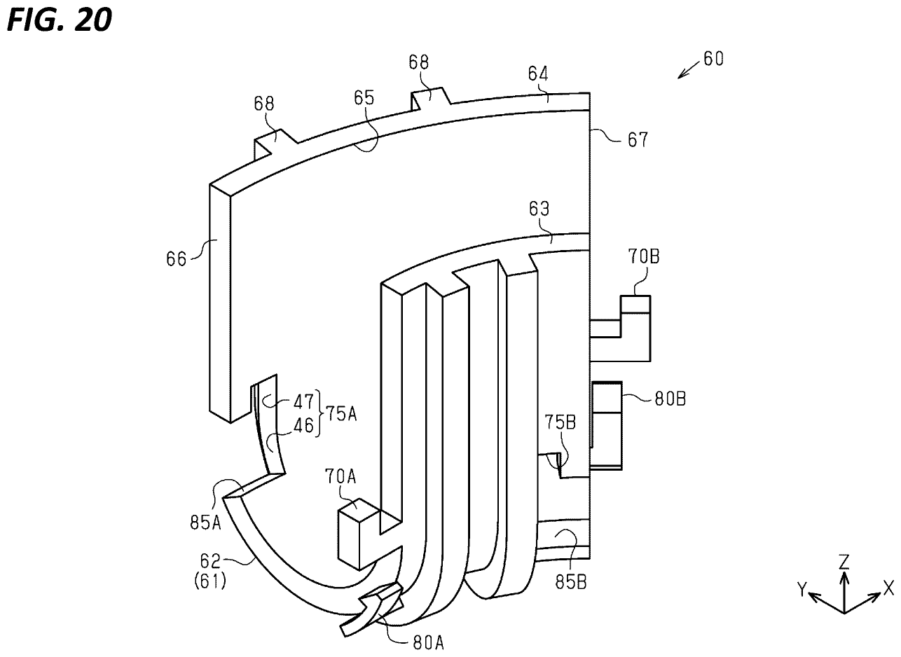

For example, as shown in FIGS. 18 and 20, the outer peripheral surface of the bent component 60 may be provided with one or more reinforcing ribs 68. The bent component 60 of this modified example has two reinforcing ribs 68. As shown in FIG. 20, each reinforcing rib 68 is formed, for example, over the entire periphery in the peripheral direction of the outer peripheral surface of the holding portion 61. Each reinforcing rib 68 is formed, for example, so as to extend continuously to the outer peripheral surface of the side wall 63, the outer peripheral surface of the bottom wall 62, and the outer peripheral surface of the side wall 64. Each reinforcing rib 68 is formed so as to protrude radially outward of the holding portion 61 from the outer peripheral surface of the holding portion 61. According to this configuration, by providing the reinforcing ribs 68, the bending rigidity of the bent component 60 can be improved.

For example, as shown in FIGS. 18 and 19, one or more groove portions 39 may be provided on the outer peripheral surface of the straight component 30. The straight component 30 of this modified example has one groove portion 39. The groove portion 39 is provided, for example, between two reinforcing ribs 38 in the axial direction of the straight component 30. The groove portion 39 is formed, for example, so as to be recessed downward from the upper surfaces of the side walls 33 and 34. The groove portion 39 is formed, for example, over the entire periphery in the peripheral direction of the outer peripheral surface of the holding portion 61.

As shown in FIG. 18, a cable tie 91 functioning as the slide restriction member 90 is accommodated in the groove portion 39. The groove portion 39 restricts the cable tie 91 from moving relative to the straight component 30 in the axial direction of the straight component 30.

A groove portion similar to the groove portion 39 shown in FIG. 18 may be provided on the outer peripheral surface of the bent component 60 in the first embodiment.

### Second Embodiment

Hereinafter, a second embodiment of the path restriction member and the wire harness will be described.

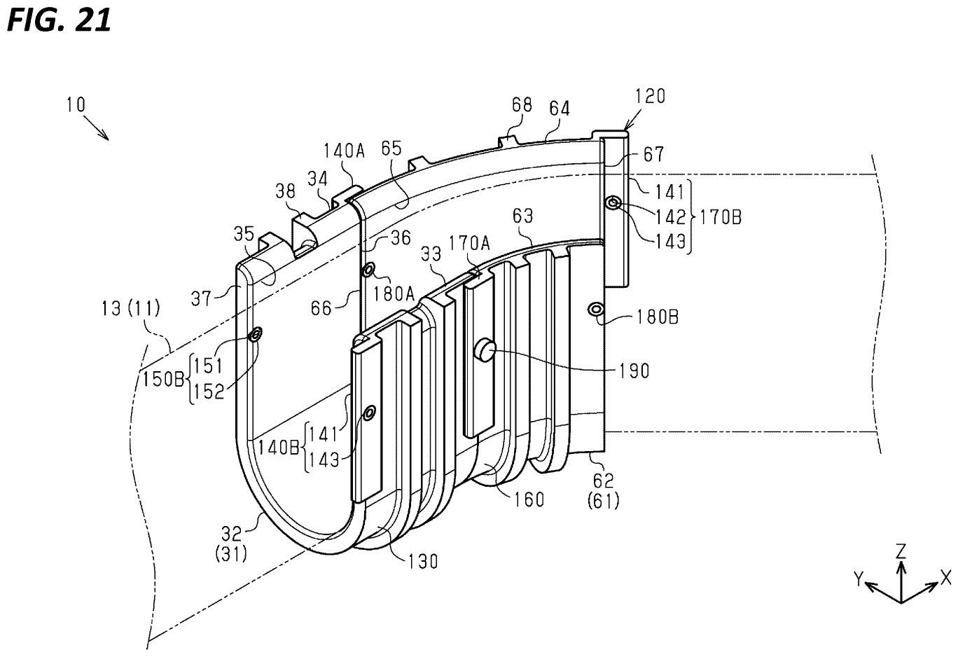

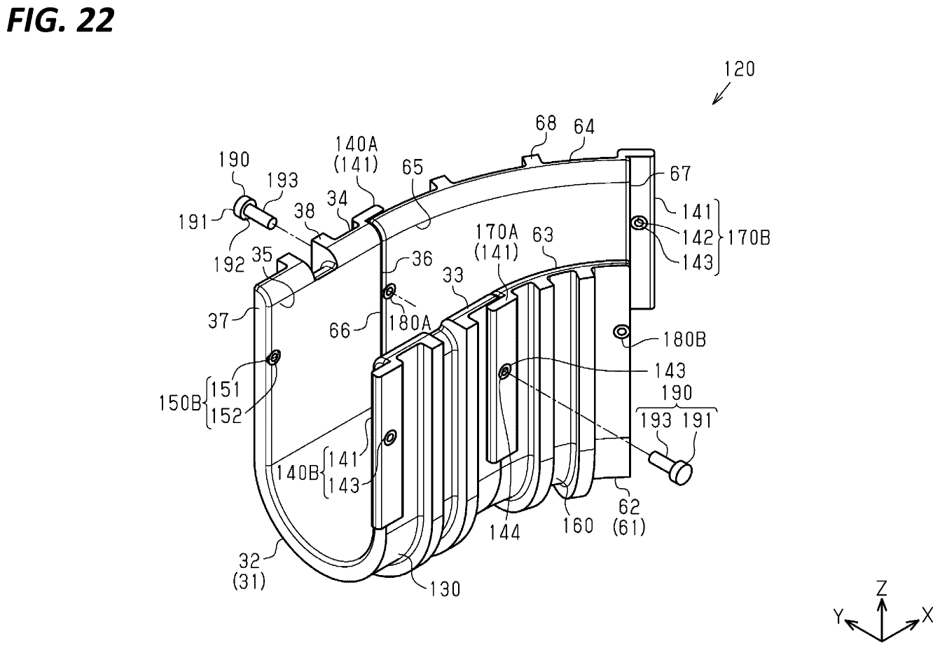

As shown in FIGS. 21 and 22, in a path restriction member 120 of this embodiment, the straight component 30 shown in FIG. 4 is modified to a straight component 130, and the bent component 60 shown in FIG. 4 is modified to a bent component 160. The path restriction member 120 of this embodiment is formed by coupling one straight component 130 and one bent component 160 to each other. In the path restriction member 120, the straight component 130 and the bent component 160 are coupled to each other by a coupling pin 190. The structures of the straight component 130, the bent component 160, and the coupling pin 190 will be described in detail below. Note that in the straight component 130 and the bent component 160, the same configurations as those of the straight component 30 and the bent component 60 are denoted by the same reference numerals, and some or all of the description thereof is omitted in some cases.

### Configuration of Straight Component 130

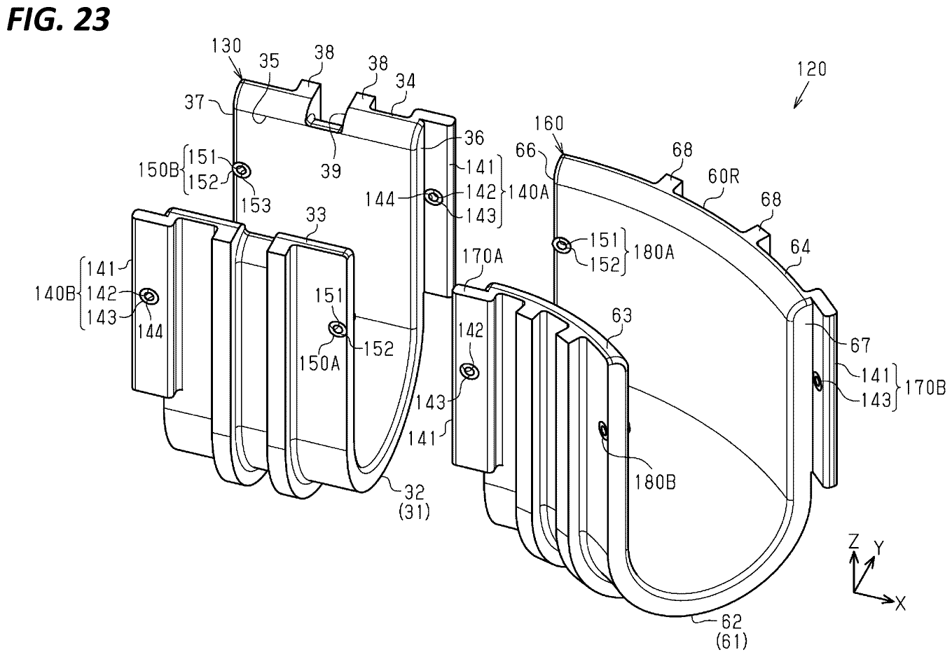

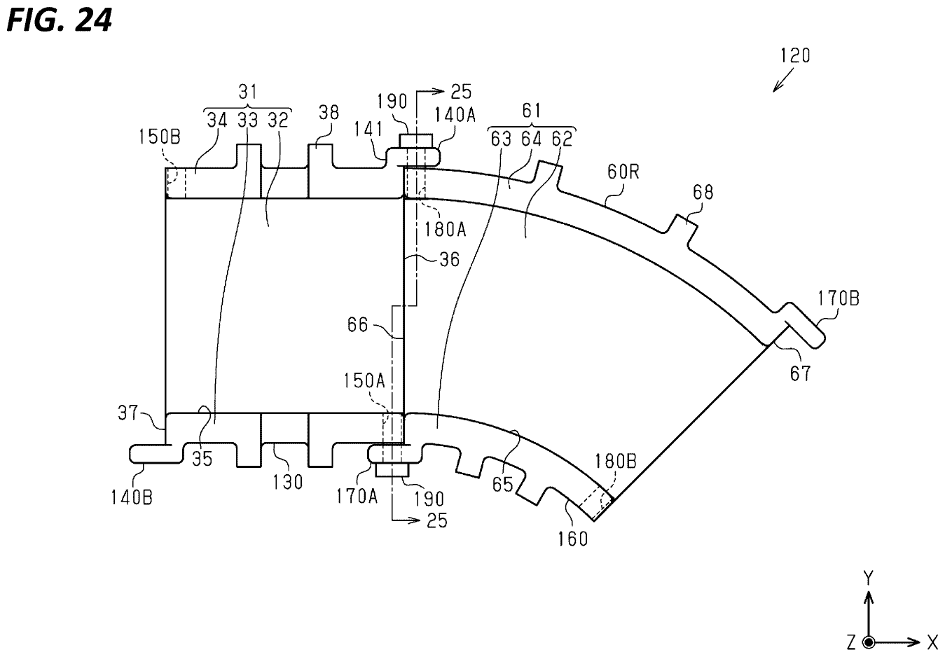

As shown in FIGS. 23 and 24, the straight component 130 includes a holding portion 31 having a bottom wall 32 and side walls 33 and 34, coupling portions 140A and 140B having the same structure as each other, and two coupling portions 150A and 150B having the same structure as each other. The straight component 130 is formed, for example, in a shape that is point-symmetric with respect to the central axis of the straight component 130 that passes through the center of the straight component 130 in the XY plane and extends in the Z-axis direction.

As shown in FIG. 23, the holding portion 31 includes, for example, reinforcing ribs 38. The holding portion 31 of this embodiment includes two reinforcing ribs 38.

The coupling portion 140A is provided on the outer peripheral surface of the side wall 34 at the end portion 36. The coupling portion 140B is provided on the outer peripheral surface of the side wall 33 at the end portion 37. The coupling portion 150A is provided on the side wall 33 at the end portion 36. The coupling portion 150B is provided on the side wall 34 at the end portion 37. The two coupling portions 140A and 140B are provided at positions that are point-symmetrical to each other with respect to the central axis of the straight component 130 that extends parallel to the Z-axis direction, in a plan view from the Z-axis direction. The two coupling portions 150A and 150B are provided at positions that are point-symmetrical to each other with respect to the central axis of the straight component 130 that extends parallel to the Z-axis direction, in a plan view from the Z-axis direction.

Next, a specific structure of the coupling portion 140A will be described. Note that since the coupling portion 140B has the same structure as the coupling portion 140A, configurations that are the same as those of the coupling portion 140A are denoted by the same reference numerals, and detailed description thereof is omitted here.

The coupling portion 140A has a fixing portion 141 formed integrally with the holding portion 31, and a through hole 142 provided in the fixing portion 141. The coupling portion 140A has, for example, an annular elastic member 143 provided inside the through hole 142.

As shown in FIGS. 23 and 24, the fixing portion 141 is formed integrally and continuously with the side wall 34. The fixing portion 141 is formed, for example, so as to protrude radially outward of the holding portion 31 from the outer peripheral surface of the side wall 34 at the end portion 36. The fixing portion 141 is formed so as to protrude outward of the holding portion 31 along the axial direction of the holding portion 31 from the outer peripheral surface of the side wall 34. The fixing portion 141 protrudes outward in the axial direction of the holding portion 31 relative to the end surface in the axial direction of the side wall 34 at the end portion 36. As shown in FIG. 21, the fixing portion 141 is provided so as to be able to cover, for example, the outer peripheral surface of the bent component 160 from the outer side in the radial direction of the holding portion 31.

As shown in FIG. 23, the fixing portion 141 is formed, for example, in a plate shape. The fixing portion 141 is formed in a plate shape extending in the height direction of the side wall 34 (here, the Z-axis direction) and in the axial direction of the holding portion 31 (here, the X-axis direction). The fixing portion 141 extends downward from the upper end of the side wall 34, for example. The length of the fixing portion 141 along the Z-axis direction is, for example, smaller than the length of the side wall 34 along the Z-axis direction.

The through hole 142 is formed so as to pass through the fixing portion 141 in the plate thickness direction (here, the Y-axis direction). The through hole 142 is provided in a portion of the fixing portion 141 that protrudes outward relative to the end surface in the axial direction of the side wall 34. The through hole 142 is provided in an intermediate portion in the height direction of the fixing portion 141 (here, the Z-axis direction). The planar shape of the through hole 142 as viewed from the penetration direction of the through hole 142 can be any shape. In this embodiment, the planar shape of the through hole 142 as viewed from the penetration direction of the through hole 142 is formed into a circular shape.

The elastic member 143 is disposed inside the through hole 142. The elastic member 143 is configured to be elastically deformable. For example, an elastic material such as rubber or elastomer can be used as the material of the elastic member 143. The elastic member 143 in this embodiment is made of rubber.

The elastic member 143 has an insertion hole 144 into which a coupling pin 190 (see FIG. 22) is inserted. The insertion hole 144 is formed so as to pass through the elastic member 143. The elastic member 143 has an insertion hole 144 and is formed in an annular shape. The elastic member 143 is formed in an annular shape in which a peripheral wall is continuous over the entire periphery in the peripheral direction of the elastic member 143, The outer peripheral shape of the elastic member 143 is formed in a shape corresponding to the inner peripheral shape of the through hole 142. The inner peripheral shape of the elastic member 143 is formed in a shape corresponding to the outer peripheral shape of the coupling pin 190.

The planar shape of the insertion hole 144 as viewed from the penetration direction of the insertion hole 144 can be any shape. In this embodiment, the planar shape of the insertion hole 144 as viewed from the penetration direction of the insertion hole 144 is formed into a circular shape.

The elastic member 143 is, for example, an injection molded body that is formed in one piece with the fixing portion 141. The elastic member 143 is formed in one piece with the fixing portion 141 by, for example, two-color molding. In this case, the fixing portion 141 and the elastic member 143 can be handled as a single object. Note that the elastic member 143 may also be formed separately from the fixing portion 141.

Next, a specific structure of the coupling portion 150A will be described. Note that since the coupling portion 150B has the same structure as the coupling portion 150A, the same components as those of the coupling portion 150A are denoted by the same reference numerals, and detailed description thereof is omitted here.

As shown in FIG. 23, the coupling portion 150A includes a third recess 151 recessed toward the inner side in the radial direction of the holding portion 31 from the outer peripheral surface of the side wall 33 at the end portion 36, and an annular elastic member 152 provided inside the third recess 151. The third recess 151 of the present embodiment is formed so as to pass through the side wall 33 in the thickness direction (here, the Y-axis direction). The third recess 151 is provided at an intermediate portion in the height direction of the side wall 33 (here, the Z-axis direction). The third recess 151 is provided at the same position as the through hole 142 in the height direction of the side walls 33 and 34.

The planar shape of the third recess 151 as viewed from the thickness direction of the side wall 33 can be any shape. The planar shape of the third recess 151 is formed in, for example, the same shape as the planar shape of the through hole 142. In this embodiment, the planar shape of the third recess 151 as viewed in the thickness direction of the side wall 33 is formed into a circular shape.

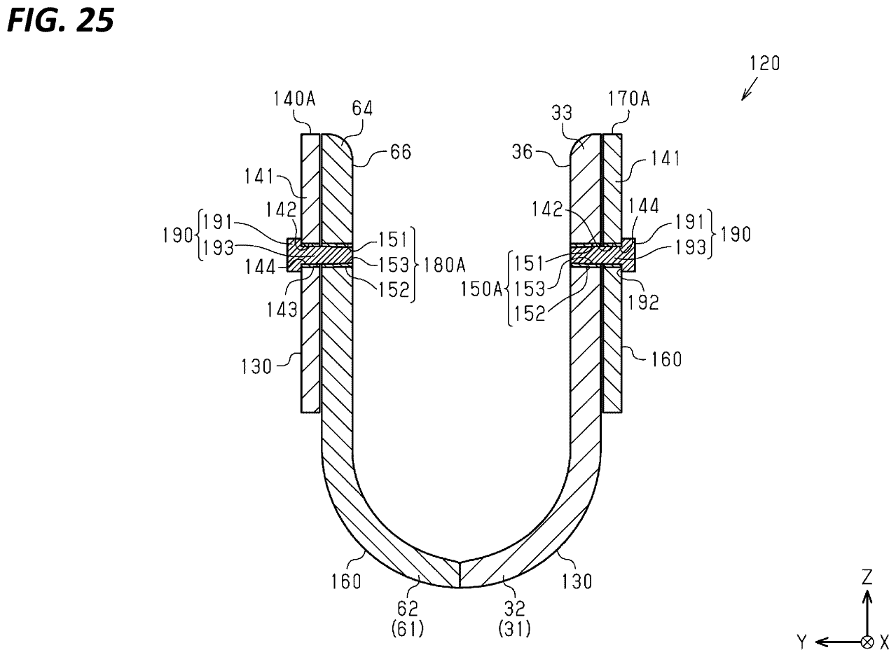

As shown in FIG. 25, the third recess 151 is formed so as to be in communication with the through hole 142 of the bent component 160. The opening width of the third recess 151 is equal to the opening width of the through hole 142, for example. For example, the inner diameter of the third recess 151 is equal to the inner diameter of the through hole 142.

The elastic member 152 is disposed inside the third recess 151. The elastic member 152 is configured to be elastically deformable. For example, an elastic material such as rubber or elastomer can be used as the material of the elastic member 152. The elastic member 152 in this embodiment is made of rubber.

The elastic member 152 has an insertion hole 153 into which the coupling pin 190 is inserted. The insertion hole 153 is formed so as to pass through the elastic member 152. The elastic member 152 has the insertion hole 153 and is formed in an annular shape. The elastic member 152 is formed in an annular shape in which a peripheral wall is continuous over the entire periphery in the peripheral direction of the elastic member 152. The outer periphery of the elastic member 152 is formed in a shape corresponding to the inner peripheral shape of the third recess 151. The inner periphery of the elastic member 152 is formed in a shape corresponding to the outer peripheral shape of the coupling pin 190.

The planar shape of the insertion hole 153 as viewed from the penetration direction of the insertion hole 153 can be any shape. In this embodiment, the planar shape of the insertion hole 153 as viewed from the penetration direction of the insertion hole 153 is formed into a circular shape.

The elastic member 152 is, for example, an injection molded body that is formed in one piece with the holding portion 31. The elastic member 152 is formed in one piece with the holding portion 31 by, for example, two-color molding. In this case, the holding portion 31 and the elastic member 152 can be handled as a single object. Note that the elastic member 152 may also be formed separately from the holding portion 31.

### Configuration of Bent Component 160

As shown in FIGS. 23 and 24, the bent component 160 includes a holding portion 61 having a bottom wall 62 and side walls 63 and 64, two coupling portions 170A and 170B having the same structure as each other, and two coupling portions 180A and 180B having the same structure as each other. The holding portion 61 is formed in a bent shape having a bent portion 60R. The holding portion 61 includes, for example, one or more reinforcing ribs 68 (two in this embodiment).

The coupling portion 170A is provided on the outer peripheral surface of the side wall 63 at the end portion 66. The coupling portion 170B is provided on the outer peripheral surface of the side wall 64 at the end portion 67. The coupling portion 180A is provided on the side wall 64 at the end portion 66. The coupling portion 180B is provided on the side wall 63 at the end portion 67. At the end portion 66 of the bent component 160, the coupling portion 170A is provided on the side wall 63, and the coupling portion 180A is provided on the side wall 64. On the other hand, at the end portion 67 of the bent component 160, the coupling portion 170B having the same structure as the coupling portion 170A is provided on the side wall 64, and the coupling portion 180B having the same structure as the coupling portion 180A is provided on the side wall 63. In this manner, the coupling portions 170B and 180B provided at the end portion 67 are formed to have structures that are 180-degree rotations of the structures of the coupling portions 170A and 180A provided at the end portion 66.

As shown in FIG. 23, each of the two coupling portions 170A and 170B has the same structure as the coupling portion 140A of the straight component 130. That is, each of the two coupling portions 170A and 170B has a fixing portion 141, a through hole 142, and an elastic member 143. Each of the two coupling portions 180A and 180B has the same structure as the coupling portion 150A of the straight component 130. That is, each of the two coupling portions 180A and 180B has a third recess 151 and an elastic member 152. Here, detailed description of the structures of the coupling portions 170A and 170B and the coupling portions 180A and 180B is omitted.

### Configuration of Coupling Pin 190

As shown in FIG. 25, the path restriction member 120 includes two coupling pins 190. One coupling pin 190 is provided to couple the coupling portion 140A of the straight component 130 and the coupling portion 180A of the bent component 160 to each other. One coupling pin 190 is provided to couple the coupling portion 150A of the straight component 130 and the coupling portion 170A of the bent component 160 to each other. In the following, a description will be given focusing on the coupling pin 190 coupling the coupling portions 140A and 180A out of the two coupling pins 190. However, the description will also refer to the coupling pin 190 that couples the coupling portions 150A and 170A.

The coupling pin 190 includes a head portion 191 and a columnar insertion portion 193 that extends from the head portion 191 and is inserted into the through hole 142 of the coupling portion 140A and the third recess 151 of the coupling portion 180A. The head portion 191 is formed to a size such that it cannot be inserted into the insertion hole 144. The head portion 191 is formed to a size such that it cannot be inserted into the through hole 142. The head portion 191 has an opposing surface 192 that opposes the fixing portion 141. The insertion portion 193 extends from the opposing surface 192 of the head portion 191 along the penetration direction of the through hole 142 (here, the Y-axis direction). The insertion portion 193 of the present embodiment is formed in a cylindrical shape. The insertion portion 193 is inserted into the insertion hole 144 of the coupling portion 140A and the insertion hole 153 of the coupling portion 180A.

The outer diameter of the insertion portion 193 is set to be, for example, greater than or equal to the inner diameter of the insertion hole 144 and greater than or equal to the inner diameter of the insertion hole 153. As a result, when the insertion portion 193 of the coupling pin 190 is pressed into the insertion holes 144 and 153, the elastic members 143 and 152 are elastically deformed so as to be pressed against the outer peripheral surface of the insertion portion 193. The insertion portion 193 is configured to be press-fitted into the insertion holes 144 and 153, for example.

The length of the insertion portion 193 along the Y-axis direction is set, for example, to be less than or equal to the length obtained by adding together the length of the insertion hole 144 along the Y-axis direction and the length of the insertion hole 153 along the Y-axis direction. This makes it possible to suitably prevent the leading end of the insertion portion 193 from protruding inward relative to the inner surface of the side wall 64.

### Coupling Structure of Straight Component 130 and Bent Component 160

As shown in FIGS. 21 and 22, the bent component 160 is coupled to the end portion 36 in the axial direction of the straight component 130. More specifically, as shown in FIG. 22, first, the straight component 130 and the bent component 160 are arranged such that the end portion 66 of the bent component 160 comes into contact with the end portion 36 of the straight component 130. At this time, the fixing portion 141 of the coupling portion 140A is disposed so as to cover the outer peripheral surface of the side wall 64 of the bent component 160, and the fixing portion 141 of the coupling portion 170A is disposed so as to cover the outer peripheral surface of the side wall 33 of the straight component 130. Furthermore, as shown in FIG. 25, the straight component 130 and the bent component 160 are arranged such that the insertion hole 144 of the coupling portion 140A is in communication with the insertion hole 153 of the coupling portion 180A, and such that the insertion hole 144 of the coupling portion 170A is in communication with the insertion hole 153 of the coupling portion 150A.

Next, the coupling pin 190 is inserted into the insertion hole 144 of the coupling portion 140A and the insertion hole 153 of the coupling portion 180A. Specifically, the insertion portion 193 of the coupling pin 190 is pushed into the insertion holes 144 and 153 of the coupling portions 140A and 180A until the opposing surface 192 of the head portion 191 of the coupling pin 190 comes into contact with the outer peripheral surface of the fixing portion 141 of the coupling portion 140A. At this time, since the outer diameter of the insertion portion 193 is set to a size that is greater than or equal to the inner diameter of the insertion holes 144 and 153, the elastic members 143 and 152 of the coupling portions 140A and 180A are elastically deformed so as to be pressed against the outer peripheral surface of the insertion portion 193. The elastic deformation of these elastic members 143 and 152 can suppress the coupling pin 190 from coming out of the insertion holes 144 and 153. The coupling pin 190 couples the coupling portion 140A of the straight component 130 and the coupling portion 180A of the bent component 160 to each other.

Similarly, the coupling pin 190 is inserted into the insertion hole 144 of the coupling portion 170A and the insertion hole 153 of the coupling portion 150A. The coupling pin 190 couples the coupling portion 150A of the straight component 130 and the coupling portion 170A of the bent component 160 to each other.

According to the second embodiment described above, in addition to the effects of (1-1), (1-2), (1-3) and (1-9) of the first embodiment, the following effects can be achieved.

(2-1) The path restriction member 120 includes the coupling pin 190 that couples the coupling portion 170A and the coupling portion 150A. The coupling portion 170A has the fixing portion 141 that protrudes outward of the holding portion 61 from the outer peripheral surface of the side wall 63 along the axial direction of the holding portion 61, and the through hole 142 provided in the fixing portion 141. The coupling portion 150A has the third recess 151 that is in communication with the through hole 142. The fixing portion 141 is engaged with the outer peripheral surface of the straight component 130, specifically, the outer peripheral surface of the side wall 33 in the radial direction of the holding portion 61. The coupling pin 190 has the columnar insertion portion 193 that is inserted into the through hole 142 and the third recess 151.

According to this configuration, the insertion portion 193 of the coupling pin 190 is inserted into the through hole 142 of the coupling portion 170A and the third recess 151 of the coupling portion 150A. The coupling pin 190 couples the coupling portion 170A and the coupling portion 150A to each other. In addition, when the coupling portion 170A is coupled to the coupling portion 150A, the fixing portion 141 of the coupling portion 170A and the outer peripheral surface of the side wall 33 of the straight component 130 are engaged with each other in the radial direction of the holding portion 61. This makes it possible to suitably suppress movement of the straight component 130 relative to the bent component 160 in the radial direction of the holding portion 61.

(2-2) In addition, when the coupling portion 170A is coupled to the coupling portion 150A, the insertion portion 193 of the coupling pin 190 and the inner surface of the third recess 151 are engaged with each other in the axial direction of the path restriction member 120. This makes it possible to suitably suppress movement of the straight component 130 relative to the bent component 160 in the axial direction of the path restriction member 120.

(2-3) The insertion portion 193 of the coupling pin 190 is inserted into the insertion hole 144 of the elastic member 143 provided inside the through hole 142 and the insertion hole 153 of the elastic member 152 provided inside the third recess 151. The coupling pin 190 couples the coupling portion 170A and the coupling portion 150A to each other. At this time, the outer diameter of the insertion portion 193 is set to be greater than or equal to the inner diameter of the insertion hole 144 and greater than or equal to the inner diameter of the insertion hole 153. For this reason, the inner peripheral surface of the elastic member 143 can be suitably brought into areal contact with the outer peripheral surface of the insertion portion 193, and the inner peripheral surface of the elastic member 152 can be suitably brought into areal contact with the outer peripheral surface of the insertion portion 193. As a result, the coupling pin 190 can be suitably suppressed from coming out of the insertion hole 144 and the insertion hole 153.

### Modified Example of Second Embodiment

The second embodiment can be modified as follows. The second embodiment and the following modified example can be implemented in combination with each other to the extent that no technical contradiction occurs.

The coupling structure of the path restriction member 120 in the second embodiment can be modified as appropriate. For example, the structure of the coupling pin 190 can be modified as appropriate.

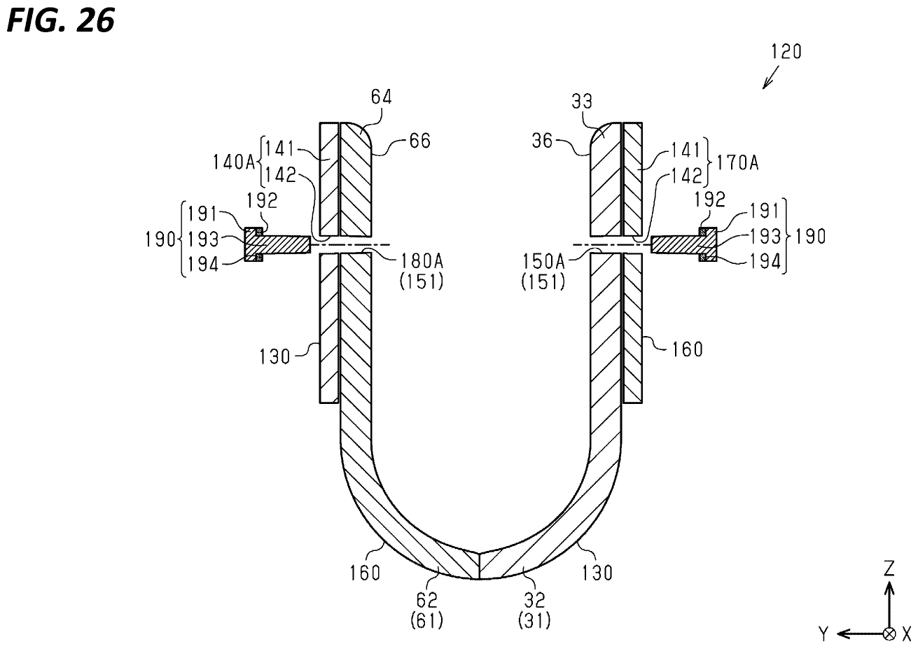

For example, as shown in FIG. 26, the coupling pin 190 may be modified to have a structure in which an elastic member 194 with adhesive is provided on the opposing surface 192 of the head portion 191. The elastic member 194 with adhesive is formed, for example, so as to cover the entirety of the opposing surface 192 exposed from the insertion portion 193.

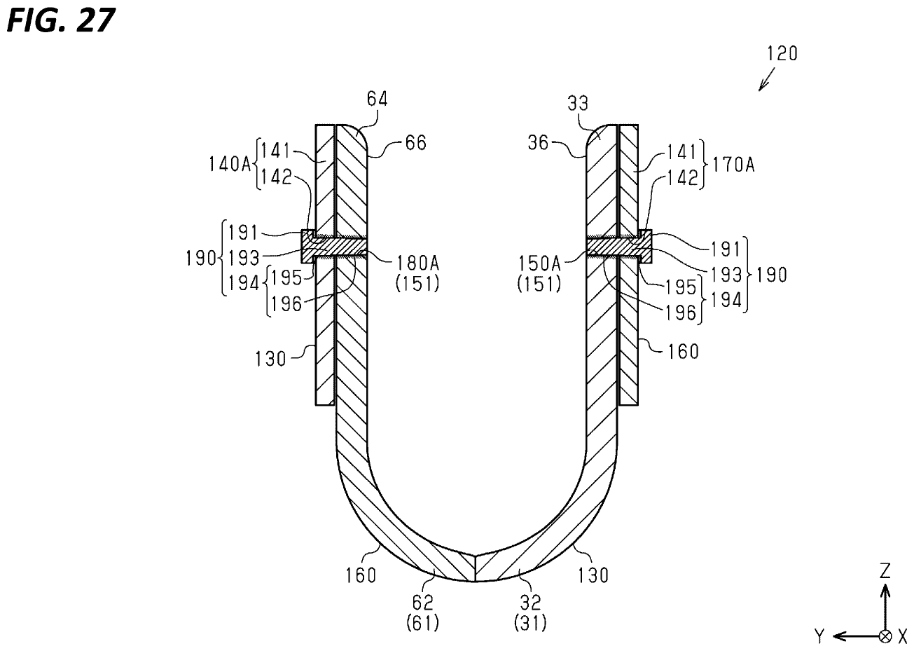

As shown in FIG. 27, the elastic member 194 with adhesive is, for example, an elastic member 195 into which an adhesive 196 has soaked. The elastic member 195 is configured to be elastically deformable. The elastic member 195 may be made of, for example, a sponge or rubber. The elastic member 195 in this modified example is a sponge. Since the sponge is porous, the adhesive 196 can suitably soak into the sponge. The adhesive 196 can be, for example, a silicone resin or an epoxy resin.

When the coupling pin 190 is pressed into the through hole 142 of the coupling portion 140A and the third recess 151 of the coupling portion 180A, the elastic member 195 is elastically deformed so as to be compressed in the insertion direction of the coupling pin 190 (here, the Y-axis direction). Upon doing so, the adhesive 196 soaked into the elastic member 195 permeates into the through hole 142 and the third recess 151 along the outer peripheral surface of the insertion portion 193. Specifically, the adhesive 196 permeates into the gap between the outer peripheral surface of the insertion portion 193 and the inner surface of the through hole 142, and the adhesive 196 permeates into the gap between the outer peripheral surface of the insertion portion 193 and the inner surface of the third recess 151. The adhesive 196 adheres the insertion portion 193 to the coupling portion 140A, and adheres the insertion portion 193 to the coupling portion 180A. In this manner, the coupling portion 140A of the straight component 130 and the coupling portion 180A of the bent component 160 are coupled by the coupling pin 190. Similarly, the coupling pin 190 having the elastic member 194 with adhesive is inserted into the through hole 142 of the coupling portion 170A and the third recess 151 of the coupling portion 150A. The adhesive 196 of the coupling pin 190 adheres the insertion portion 193 to the coupling portion 170A, and adheres the insertion portion 193 to the coupling portion 150A. As a result, the bent component 160 is coupled to and integrated with the straight component 130.

According to this configuration, the insertion portion 193 of the coupling pin 190 is adhered to the coupling portion 170A and the coupling portion 150A by the adhesive 196. This makes it possible to suitably suppress the coupling pin 190 from coming out of the through hole 142 of the coupling portion 170A and the third recess 151 of the coupling portion 150A.

In the modified example shown in FIGS. 26 and 27, the elastic members 143 and 152 are omitted, but there is no limitation to this. For example, in the modified examples shown in FIG. 26 and FIG. 27, the coupling portions 140A and 170A may include the elastic member 143, and the coupling portions 150A and 180A may include the elastic member 152.

In the second embodiment, the coupling tool is the coupling pin 190, but there is no limitation to this. That is, in the second embodiment, the coupling portion 140A and the coupling portion 180A are coupled by the coupling pin 190, but there is no limitation to this.

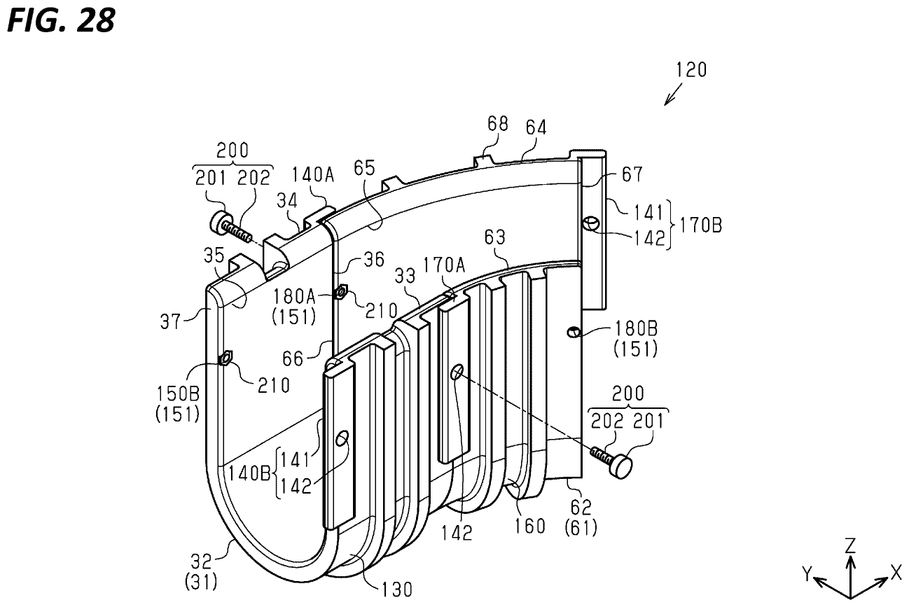

For example, as shown in FIG. 28, the coupling portion 140A and the coupling portion 180A may be coupled by screw fastening. Specifically, the coupling portion 140A and the coupling portion 180A may be coupled by screw fastening using a bolt 200 serving as a male thread and a nut 210 serving as a female thread.

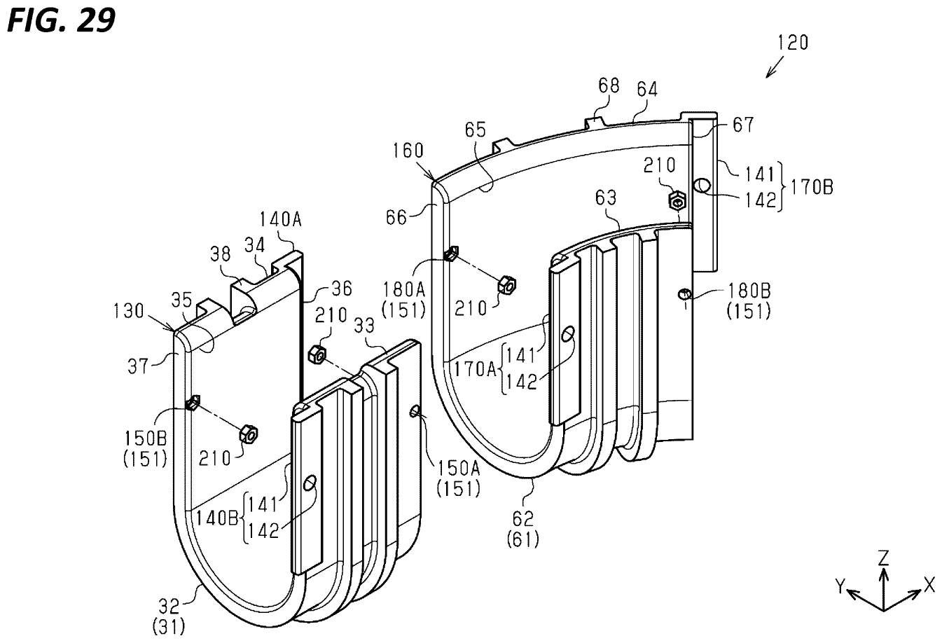

As shown in FIG. 29, the nut 210 is provided inside the third recess 151 of the coupling portion 180A. The nut 210 is formed in an annular shape. The inner peripheral surface of the nut 210 has a female thread portion that can be fastened to the bolt 200. The nut 210 is, for example, formed in one piece with the coupling portion 180A. The nut 210 is formed in one piece with the holding portion 61 by, for example, insert molding. For example, the holding portion 61 including the coupling portion 180A is formed through insert molding using the nut 210 as an insert part.

As shown in FIG. 28, the bolt 200 has a head portion 201 and a columnar insertion portion 202 extending from the head portion 201. The outer peripheral surface of the insertion portion 202 has a male thread portion that can be fastened with the nut 210. The head portion 201 is formed to a size such that it cannot be inserted into the through hole 142. The insertion portion 202 extends along the penetration direction (here, the Y-axis direction) of the through hole 142. The insertion portion 202 of this modified example is formed in a cylindrical shape. The insertion portion 202 is inserted into the through hole 142 (see FIG. 29) of the coupling portion 140A and the third recess 151 of the coupling portion 180A. The nut 210 is attached to the leading end of the insertion portion 202. In this manner, by fastening the insertion portion 202 of the bolt 200 to the nut 210 integrated with the coupling portion 180A, the coupling portion 140A and the coupling portion 180A are coupled to and integrated with each other.

Similarly, the coupling portion 170A and the coupling portion 150A may be coupled by screw fastening using the bolt 200 and the nut 210.

According to this configuration, the nut 210 is formed in one piece with the coupling portion 180A, and the leading end of the insertion portion 202 of the bolt 200 is fastened to the nut 210. The coupling portion 140A and the coupling portion 180A are coupled to each other through screw fastening using the nut 210 and the bolt 200. This makes it possible to suitably suppress the bolt 200 and the nut 210, which are the coupling tool, from coming out of the through hole 142 of the coupling portion 140A and the third recess 151 of the coupling portion 180A. In addition, by removing the bolt 200 from the nut 210, the coupled state between the coupling portion 140A and the coupling portion 180A can be easily canceled.

The structure of the through hole 142 of the fixing portion 141 in the modified example shown in FIGS. 28 and 29 may be modified as appropriate.

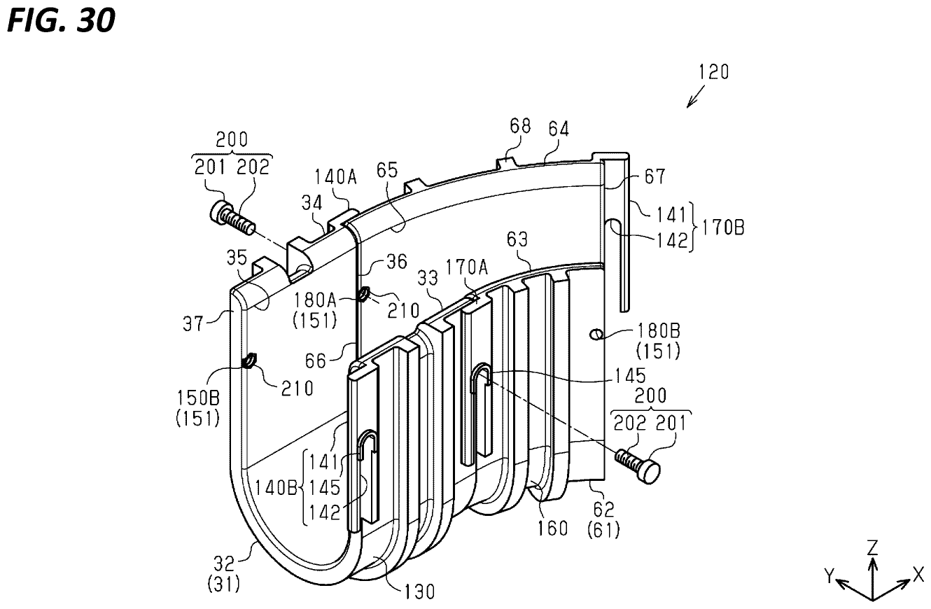

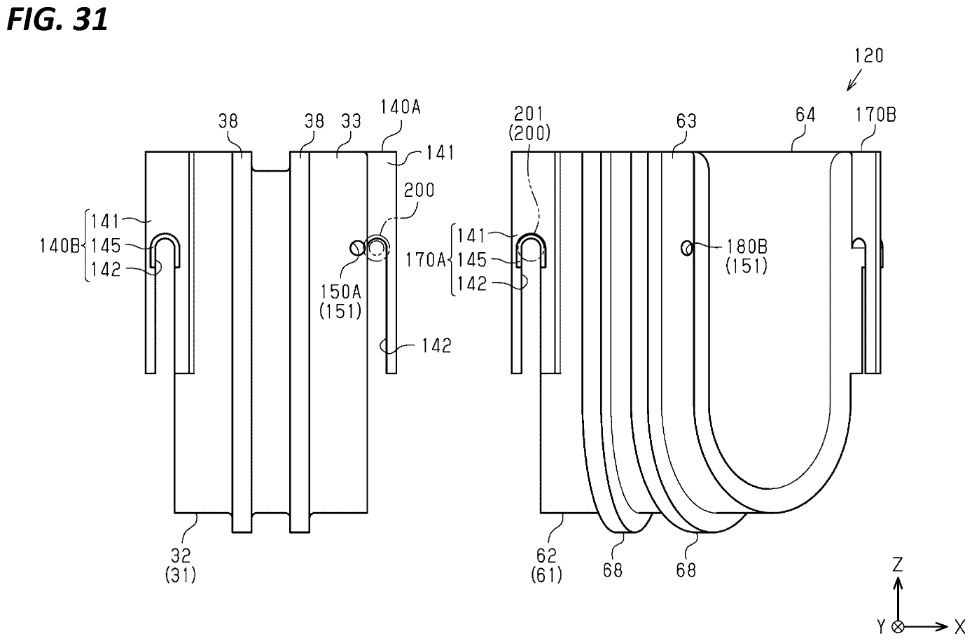

For example, as shown in FIGS. 30 and 31, the through hole 142 may be formed to extend along the height direction of the fixing portion 141 (here, the Z-axis direction). The through hole 142 of this modified example is formed so as to be open downward in the drawing in the Z-axis direction. In other words, the through hole 142 in this modified example is formed so as to be recessed upward in the drawing from the lower end surface of the fixing portion 141. The through hole 142 in this modified example is formed in a notch shape.

As shown in FIG. 30, the coupling portion 170A may be provided with a rib 145 protruding from the outer peripheral surface of the fixing portion 141 toward the outside in the radial direction of the holding portion 61. The rib 145 is provided on the outer peripheral surface of the fixing portion 141 located on the peripheral edge of the through hole 142.

As shown in FIG. 31, the rib 145 is provided at a portion that comes into contact with the head portion 201 of the bolt 200. The rib 145 is formed so as to surround the through hole 142 in a plan view from the penetration direction of the through hole 142 (here, the Y-axis direction). In this modified example, the planar shape of the rib 145 as viewed from the Y-axis direction is formed into a U-shape.

According to this configuration, the rib 145 is provided on the portion of the outer peripheral surface of the fixing portion 141 that comes into contact with the head portion 201 of the bolt 200. The rib 145 can increase the rigidity of the fixing portion 141. For this reason, when the bolt 200 is fastened to the nut 210, the occurrence of cracks or the like in the fixing portion 141 due to the fastening force can be suitably suppressed.

The ribs 145 in the modified example shown in FIGS. 30 and 31 may be omitted.

The fixing portion 141 shown in FIGS. 28 and 29 may be provided with a rib 145. In this case, the rib 145 may be formed so as to surround the entire periphery in the peripheral direction of the through hole 142 in a plan view from the penetration direction of the through hole 142. In this case, the rib 145 is formed, for example, in a cylindrical shape.

In the modified examples shown in FIGS. 28 to 31, the nut 210 is provided only inside the third recess 151, but there is no limitation to this. For example, the nut 210 may be provided inside the third recess 151 and inside the through hole 142. For example, the nut 210 may also be provided only inside the through hole 142.

In the modified examples shown in FIGS. 28 to 31, the nut 210 is formed in one piece with the coupling portion 180A, but the bolt 200 may also be formed in one piece with the coupling portion 180A. In this case, for example, the leading end of the insertion portion 202 of the bolt 200 is provided so as to protrude outward relative to the outer peripheral surface of the fixing portion 141. Then, the nut 210 is fastened to the leading end of the insertion portion 202. At this time, the nut 210 is formed to a size such that it cannot be inserted into the through hole 142.

In the modified examples shown in FIGS. 28 to 31, if a female thread portion is formed in either the third recess 151 or the through hole 142, the nut 210 may be omitted.

In the second embodiment and the above-described modified examples, the third recess 151 was formed so as to pass through the side walls 33, 34, 63, and 64 in the thickness direction, but there is no limitation to this. The third recess 151 may be formed so as not to pass through the side walls 33, 34, 63, and 64 in the thickness direction. In this case, the third recess 151 is formed so as to be recessed from the outer peripheral surfaces of the side walls 33, 34, 63, and 64 toward the inside in the radial direction of the holding portions 31 and 61.

The reinforcing ribs 38 and 68 in the second embodiment and the above-described modified examples may also be omitted.

The structure of the path restriction member 120 in the second embodiment can be modified as appropriate. For example, by changing the combination of the straight components 130 and the bent components 160, that is, the numbers and the coupling directions of the straight components 130 and the bent components 160, the path restriction member 120 can be formed into various structures. The numbers of the straight components 130 and the bent components 160 that are included in the path restriction member 120 are not particularly limited. For example, similarly to the modified example shown in FIGS. 16 and 17, the path restriction member 120 may be formed by coupling two bent components 160 together.

### Other Embodiments

The above-described embodiments can be modified as follows. The above-described embodiments and the following modified examples can be implemented in combination with each other to the extent that no technical contradiction occurs.

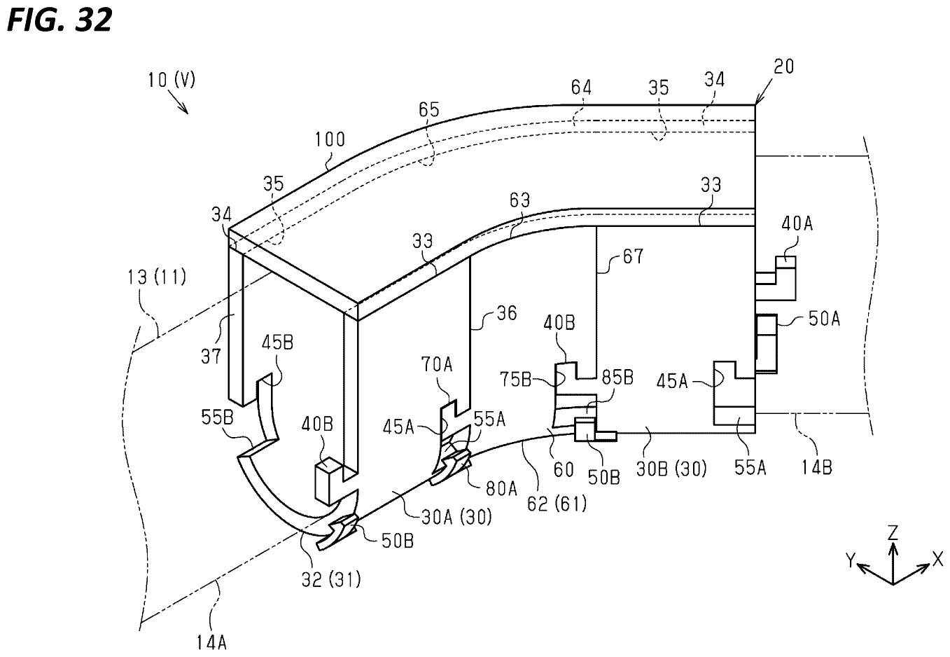

For example, as shown in FIG. 32, the path restriction member 20 may also include a lid portion 100 that closes the insertion openings 35 of the straight components 30A and 30B and the insertion opening 65 of the bent component 60. The lid portion 100 is provided so as to entirely cover the insertion openings 35 of the straight components 30A and 30B and entirely cover the insertion opening 65 of the bent component 60, for example. The lid portion 100 is provided on the upper surfaces of the side walls 33 and 34 of the straight components 30A and 30B, and is provided on the upper surfaces of the side walls 63 and 64 of the bent component 60, for example. The lid portion 100 is coupled to the straight components 30A and 30B and the bent component 60 by, for example, coupling members (not shown). Note that the lid portion 100 may also be formed by a body panel of a vehicle V. Similarly, the path restriction member 120 may also include the lid portion 100.

The size of the bending angle θ in the bent portions 60R of the bent components 60 and 160 in the above-described embodiments can be modified as appropriate.

The electric wire member 11 of the above-described embodiments does not necessarily need to include the exterior member 13. That is, the exterior member 13 may be omitted from the electric wire member 11, and the holding portions 31 and 61 may directly hold the electric wires 12.

The electric wire member 11 of the above-described embodiments may also include a tubular electromagnetic shield member that surrounds the outer periphery of the electric wire 12.

The arrangement relationship between the inverter M1 and the high-voltage battery M2 in the vehicle V is not limited to those in the above-described embodiments, and may be modified as appropriate depending on the vehicle configuration.

The plurality of electric devices to which the wire harness 10 of the above-described embodiments are electrically connected are not limited to the inverter M1 and the high-voltage battery M2, and are not particularly limited as long as they are electrical devices mounted in the vehicle V.

The embodiments disclosed herein are to be considered as illustrative in all respects and not restrictive. The scope of the present invention is defined not by the above meaning, but by the claims, and is intended to encompass all modifications within the meaning and scope equivalent to the claims.

### LIST OF REFERENCE NUMERALS

10 Wire harness
11 Electric wire member
12 Electric wire
13 Exterior member
14A, 14B, 14C, 14D, 14E, 14F Straight portion
15A, 15B, 15C, 15D, 15E Bent portion
20, 20A, 20B, 20C, 20D, 20E Path restriction member
30, 30A, 30B Straight component (restricting component)
31 Holding portion (second holding portion)
32 Bottom wall (second bottom wall)
33 Side wall (fourth side wall)
34 Side wall (third side wall)
35 Insertion opening (second insertion port)
36 End portion (third end portion)
37 End portion (fourth end portion)
38, 68 Reinforcing rib
39 Groove portion
40A Coupling portion (fifth coupling portion)
40B Coupling portion (seventh coupling portion)
41 Protruding portion
42 Engaging projection
43 Recess
45A Coupling portion (sixth coupling portion)
45B Coupling portion (eighth coupling portion)
46 First recess
46A First inner surface
46B Second inner surface
46C Bottom surface
47 Second recess
50A Engagement portion (fifth engagement portion)
50B Engagement portion
51 Base portion
52 Elastic piece
53 Engaging piece
55A Engagement portion (sixth coupling portion)
55B Engagement portion
60 Bent component
60A Bent component (first bent component)
60B Bent component (restricting component, second bent component)
60R Bent portion
61 Holding portion (first holding portion)
62 Bottom wall (first bottom wall)
63 Side wall (first side wall)
64 Side wall (second side wall)
65 Insertion opening (first insertion port)
66 End portion (first end portion)
67 End portion (second end portion)
70A Coupling portion (first coupling portion)
70B Coupling portion (third coupling portion)
75A Coupling portion (second coupling portion)
75B Coupling portion (fourth coupling portion)
80A Engagement portion (first engagement portion)
80B Engagement portion (third engagement portion)
85A Engagement portion (second engagement portion)
85B Engagement portion (fourth engagement portion)
90 Slide restriction member
91 Cable tie
100 Lid portion
120 Path restriction member
130 Straight component (restricting component)
140A Coupling portion (fifth coupling portion)
140B Coupling portion (seventh coupling portion)
141 Fixing portion
142 Through hole
143 Elastic member (first elastic member)
144 Insertion hole (first insertion hole)
145 Rib
150A Coupling portion (sixth coupling portion)
150B Coupling portion (eighth coupling portion)
151 Third recess
152 Elastic member (second elastic member)
153 Insertion hole (second insertion hole)
160 Bent component
170A Coupling portion (first coupling portion)
170B Coupling portion (third coupling portion)
180A Coupling portion (second coupling portion)
180B Coupling portion (fourth coupling portion)
190 Coupling pin (coupling tool)
191 Head portion
192 Opposing surface
193 Insertion portion
194 Elastic member with adhesive
195 Elastic member
196 Adhesive
200 Bolt (coupling tool, male thread)
201 Head portion
202 Insertion portion
210 Nut (coupling tool, female thread)
θ, θ1, θ2, θ3, θ4, θ5 Bending angle
C1, C2 Connector
L1, L2, L3, L4, L5, L6 Central axis
M1 Inverter
M2 High-voltage battery
V Vehicle

1. A path restriction member for restricting a path of an electric wire member, the path restriction member comprising:
a bent component including a first holding portion that is configured to hold the electric wire member and has a bent portion, a first coupling portion, a second coupling portion, a third coupling portion having the same structure as the first coupling portion, and a fourth coupling portion having the same structure as the second coupling portion; and
a restricting component including a second holding portion configured to hold the electric wire member, a fifth coupling portion coupled to the second coupling portion, and a sixth coupling portion coupled to the first coupling portion,
wherein the first holding portion has a first bottom wall, and a first side wall and a second side wall protruding from both side edges of the first bottom wall,
the bent component has a first end portion and a second end portion in an axial direction of the bent component,
the first coupling portion is provided at the first end portion on the first side wall,
the second coupling portion is provided at the first end portion on the second side wall,
the third coupling portion is provided at the second end portion on the second side wall, and
the fourth coupling portion is provided at the second end portion on the first side wall.

2. The path restriction member according to claim 1, wherein the restricting component includes the fifth coupling portion having the same structure as the first coupling portion, the sixth coupling portion having the same structure as the second coupling portion, a seventh coupling portion having the same structure as the fifth coupling portion, and an eighth coupling portion having the same structure as the sixth coupling portion,
the second holding portion has a second bottom wall, and a third side wall and a fourth side wall protruding from both side edges of the second bottom wall,
the second holding portion has a third end portion and a fourth end portion in an axial direction of the second holding portion,
the fifth coupling portion is provided at the third end portion on the third side wall,
the sixth coupling portion is provided at the third end portion on the fourth side wall,
the seventh coupling portion is provided at the fourth end portion on the fourth side wall, and
the eighth coupling portion is provided at the fourth end portion on the third side wall.

3. The path restriction member according to claim 1,
wherein the first coupling portion is engaged with the sixth coupling portion in an axial direction of the path restriction member, and
the second coupling portion is engaged with the fifth coupling portion in the axial direction of the path restriction member.

4. The path restriction member according to claim 3,
wherein the first coupling portion has a protruding portion protruding from the first end portion on the first side wall along an axial direction of the first holding portion, and an engaging projection protruding from a leading end of the protruding portion along a height direction of the first side wall,
the sixth coupling portion has a first recess into which the protruding portion fits and a second recess into which the engaging projection fits, and
a side surface of the engaging projection is engaged with an inner surface of the second recess in the axial direction of the path restriction member.

5. The path restriction member according to claim 4,
wherein each of the first side wall and the second side wall is formed in a plate shape, and
a length of the engaging projection along the axial direction of the path restriction member is greater than a length of the first side wall along a thickness direction of the first side wall.

6. The path restriction member according to claim 1,
wherein in a plan view from a height direction of the first side wall, the bent component has a first engagement portion provided at a position overlapping with the first coupling portion, a second engagement portion provided at a position overlapping with the second coupling portion, a third engagement portion provided at a position overlapping with the third coupling portion, and a fourth engagement portion provided at a position overlapping with the fourth coupling portion,
the restricting component has a fifth engagement portion engaged with the second engagement portion in the peripheral direction of the path restriction member, and a sixth engagement portion engaged with the first engagement portion in the peripheral direction of the path restriction member,
each of the third engagement portion and the fifth engagement portion has the same structure as the first engagement portion, and
each of the fourth engagement portion and the sixth engagement portion has the same structure as the second engagement portion.

7. The path restriction member according to claim 6,
wherein the first engagement portion has a base portion that protrudes outward of the first holding portion along the axial direction of the first holding portion from an outer peripheral surface of the first holding portion, an elastic piece that protrudes from a leading end of the base portion along the peripheral direction of the first holding portion, and an engagement claw that is provided at a leading end of the elastic piece and is engaged with the sixth engagement portion.

8. The path restriction member according to claim 1, further comprising
a coupling tool coupling the first coupling portion and the sixth coupling portion,
wherein the first coupling portion includes a fixing portion that protrudes outward of the first holding portion along the axial direction of the first holding portion from an outer peripheral surface of the first side wall, and a through hole provided in the fixing portion, the sixth coupling portion includes a third recess that is in communication with the through hole,
the fixing portion is engaged with an outer peripheral surface of the restricting component in a radial direction of the first holding portion, and
the coupling tool has a columnar insertion portion inserted into the through hole and the third recess.

9. The path restriction member according to claim 8,
wherein the first coupling portion includes an annular first elastic member that is provided inside the through hole and has a first insertion hole,
the sixth coupling portion includes an annular second elastic member that is provided inside the third recess and has a second insertion hole,
the coupling tool is a coupling pin having a head portion and the insertion portion that extends from the head portion and is inserted into the first insertion hole and the second insertion hole, and
an outer diameter of the insertion portion is set to be greater than or equal to an inner diameter of the first insertion hole and greater than or equal to an inner diameter of the second insertion hole.

10. The path restriction member according to claim 8,
wherein the coupling tool is a coupling pin that has a head portion having an opposing surface opposing the fixing portion, the insertion portion that extends from the opposing surface and is inserted into the through hole and the third recess, and an elastic member with adhesive, the elastic member with adhesive being provided on the opposing surface,
a portion of the adhesive of the elastic member with adhesive permeates into the through hole and the third recess, and
the insertion portion is adhered to the first coupling portion by the adhesive and is adhered to the sixth coupling portion by the adhesive.

11. The path restriction member according to claim 8,
wherein the coupling tool has a male thread having the insertion portion and a female thread fastened to the male thread, and
the first coupling portion is screw-fastened to the sixth coupling portion by the male thread and the female thread.

12. The path restriction member according to claim 11,
wherein the female thread is a nut that is provided inside the third recess and is formed in one piece with the sixth coupling portion,
the male thread is a bolt having a head portion and the insertion portion extending from the head portion, and
a leading end of the insertion portion is fastened to the nut while passing through the through hole.

13. The path restriction member according to claim 12,
wherein the first coupling portion has a rib protruding toward an outer side in a radial direction of the first holding portion from an outer peripheral surface of the fixing portion,
the rib is formed so as to surround the through hole in a plan view from a penetration direction of the through hole, and
the rib is in contact with the head portion of the bolt.

14. The path restriction member according to claim 1,
wherein the restricting component is a straight component formed so as to extend linearly in one direction.

15. The path restriction member according to claim 1,
wherein when the bent component is a first bent component, the restricting component is a second bent component having the same structure as the first bent component.

16. The path restriction member according to claim 1,
wherein the bent component has a first insertion opening that is open in a direction perpendicular to the axial direction of the bent component and extends over the entire length in the axial direction of the bent component,
the restricting component has a second insertion opening that is open in a direction perpendicular to the axial direction of the restricting component and extends over the entire length in the axial direction of the restricting component, and
the first insertion opening is in communication with the second insertion opening.

17. A wire harness comprising:
the path restriction member according to claim 1 and
the electric wire member whose path is restricted by the path restriction member.
